(19) United States
(12) Patent Application Publication
(10) Pub. No.: US 2015/0379416 A1
(43) Pub. Date: Dec. 31, 2015

(54) DECISION ASSISTANCE SYSTEM

(71) Applicant: QuDec, Inc., Cupertino, CA (US)

(72) Inventor: Samuel HOLTZMAN, Cupertino, CA (US)

(21) Appl. No.: 14/749,484

(22) Filed: Jun. 24, 2015

Related U.S. Application Data
(60) Provisional application No. 62/018,391, filed on Jun. 27, 2014.

(51) Int. Cl. G06N 5/04

(52) U.S. Cl. CPC G06N 5/045

(57) ABSTRACT

A decision-assistance system provides a tool for decision makers to receive assistance in making a decision. Through a web page, a decision maker selects a group of one or more advisers and inputs information describing a decision to be made. The decision maker solicits advice from the group of advisers, and the advisers provide advice to assist the decision maker. Other entities can be granted access to streams of information corresponding to particular themes of the decisions to be made. Business entities, for example, can use the streams of information to connect with decision makers facing decisions relevant to the goods and services provided by the business entity.

### BACKGROUND

1. Technical Field

The present disclosure generally relates to a social-networking system. More particularly, but not exclusively, the present disclosure relates to an electronic request for assistance with a decision extended by a user of a first computing device to one or more other users of respective second computing devices wherein the computing devices are connected via a network.

2. Description of the Related Art

In many computing activities, a user of one personal computing device participates in an interactive relationship with one or more other users via their personal computing devices. This type of interactive relationship between people using computers as a medium of communication is generally known as a social network. In a social network, a first user can display or otherwise present information about any number of topics. Other users who are associated with the first user can access the information. The other users can also present information that is accessible to the first user.

In a social-networking system, many people form social-network relationships. Dozens, hundreds, thousands, and millions of people can share the resources of a single social-networking system. The users can form interactive social-network relationships with each other such that the social-networking system may host dozens, hundreds, thousands, and millions of distinct and overlapping social networks. A user may be associated with one social network or more than one social network. For example, a user may have a first social network that includes family members and a second social network that includes work colleagues. A third social network may include teammates of a sports team, and a fourth social network may include family members whose child is in a particular school class. Some people may be associated with multiple social networks. A nearly infinite number of social networks could be formed based on relationships that people identify.

Each user in a social-networking system typically has access to a personal computing device. The personal computing device has a display and an input mechanism, such as a keyboard or touch screen, which permits a user of the personal computing device to input information into the personal computing device and to access information stored by the personal computing device. The personal computing device also has a network interface that permits information to flow between the personal computing device and another computing device.

Information that flows between computing devices may travel via a wired communication medium (e.g., twisted pair, coaxial cable, and the like), a wireless communication medium (e.g., satellite, cellular, Bluetooth, IEEE 802.11, and the like), or any combination of one or more wired and wireless communication media. Various hardware and software apparatuses typically facilitate the communication of information over the wired and wireless communication mediums. The communication mechanism of a social-networking system may include hardware and software configured in many ways, for example, as a personal area network (PAN), a local area network (LAN), a wide area network (WAN, e.g., the Internet), and the like.

The flow of information in a social network may be one-way or back-and-forth. The flow of information may be interactive, as in a real-time conversation. Alternatively, or in addition, the flow of information can be detached, as in the exchange of letters.

In one conventionally popular social-networking system, a first user can “post” information on a “wall.” The information can be multimedia information such as text, pictures, video, audio, and the like. The wall is a representation of a physical area where posted information is accessible to the first user or other users. The wall is instantiated in one or more memory devices, and all or portions of the information can be presented via the output devices of a computer (e.g., display, speakers, etc.). The area of memory where the information associated with the wall is generally controlled by the user who creates the wall. “Posting” information is synonymous with storing information in the memory controlled by the user, and “taking down” information is synonymous with deleting information from the memory.

The first user may permit others to access the information on their wall. Different users may be granted access to the same or different portions of the information on the wall. In this way, which may be very flexible, the first user can set up one or more groups of users who have access to the same or different information. For example, a first group may be personal friends of the first user, and that group has access to very personal information (e.g., family photos, political commentary, favorite songs, and the like) posted by the first user. Members of the first group may also be granted access to post information on the first user's wall for access by the first user and members of the first group. A second group, for example, may be formed of business associates. This group may be able to access information posted on a second portion of the first user's wall. This information may be less personal, such as business-related photographs, a work history, and the like. In some cases, users are granted access such that they belong to more than one group. In some cases, users of one group are granted access to information accessible by another group.

The subject matter discussed in the Background section is not necessarily prior art and should not be assumed to be prior art merely as a result of its discussion in the Background section. Along these lines, any recognition of problems in the prior art discussed in Background section or associated with such subject matter should not be treated as prior art unless expressly stated to be prior art. Instead, the discussion of any subject matter in the Background section should be treated as part of the inventor's approach to the particular problem, which in and of itself may also be inventive.

### BRIEF SUMMARY

In accordance with some embodiments described herein, a computing server facilitates a social network. A plurality of users may be associated as a group. One user can post information to other users of the group such that the information represents a request for help making a decision.

In accordance with some embodiments described herein, a decision-assistance system provides a tool for decision makers to receive assistance (e.g., advice) in making a decision. Through a web page, a decision maker selects a group of one or more advisers and inputs information describing a decision to be made. The decision maker solicits advice from the group of advisers, and the advisers provide advice to assist the decision maker. Other entities can be granted access to streams of information corresponding to particular themes of the decisions to be made. A theme, for example, may include a recognizable pattern of words and/or structure of one or more decisions to be made. Embodiments of the decision-assistance system are configured to disguise personally identifying information of a decision maker while still providing a communication path to the decision maker. Business entities, for example, can use the streams of information to connect with decision makers facing decisions relevant to the goods and services provided by the business entity.

In a first embodiment, a method to receive assistance in making a decision is provided. A decision maker operates a personal computing device to access a social network. The decision maker passes personal information, which may be appropriately disguised, through an interactive interface to a computing server communicatively coupled to the decision maker's personal computing device. The personal computing device receives displayable web page information from the computing server, and the displayable information forms at least a portion of the interactive interface. The decision maker passes first input information to the computing server via the interactive interface, which identifies a group of one or more advisers. The decision maker passes second input information to the computing server via the interactive interface, which describes a decision to be made by the decision maker. The decision maker passes third input information to the computing server via the interactive interface, which solicits advice from the group of one or more advisers. The advice being solicited includes decision assistance regarding the decision to be made. In some cases, the advice solicitation also includes possible choices, advantages and/or disadvantages for one or more choices, and a brief description of the context of the decision to be made. The decision maker receives first output information from the computing server via the interactive interface, which includes the advice.

In a second embodiment, a method to receive decision assistance information is provided. A representative of a business entity operates a personal computing device. The representative of a business entity accesses a social network via the personal computing device, which includes passing system-wide unique account information through an interactive interface to a computing server communicatively coupled to the personal computing device. The representative of a business entity receives displayable web page information from the computing server, which forms at least a portion of the interactive interface. The representative of a business entity passes first input information to the computing server via the interactive interface, which identifies at least one decision theme, the decision theme in this case including a set of words and/or linguistic structures. The representative of a business entity receives first output information from the computing server via the interactive interface, which includes an alert corresponding to the decision theme. The alert indicates at least one decision maker has solicited advice regarding a decision to be made, and the decision to be made is associated with the decision theme.

In a third embodiment, a decision-assistance server includes a processor module, one or more memory storage devices, a storage interface module coupled to the one or more memory storage devices, and an input/output interface module to pass information to and from the decision-assistance server. The information passed to and from the decision-assistance server includes first input information from a decision maker identifying a group of one or more advisers, second input information describing in human language a decision to be made by the decision maker, and first output advice information provided by the group of one or more advisers. The decision-assistance server also includes a natural-language-detection module to detect analyzable word objects within the second input information and to generate decision-to-be-made information, at least one theme operations module to determine at least one theme present amongst the second input information, and a decision processing module to coordinate communication of the decision-to-be-made information to the group of one or more advisers and to coordinate communication of the first output advice to the decision maker.

These features with other objects and advantages which will become subsequently apparent reside in the details of construction and operation as more fully described hereafter and claimed, reference being had to the accompanying drawings forming a part hereof.

### BRIEF DESCRIPTION OF THE SEVERAL VIEWS OF THE DRAWINGS

Nonlimiting and nonexhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 is an embodiment of a decision-assistance system;

FIG. 2 is an embodiment of a decision-assistance server;

FIG. 3 illustrates natural-language-processing analysis;

FIG. 4 is an embodiment of a natural-language-processing algorithm;

FIG. 5 is an embodiment of a theme-processing algorithm;

FIG. 6 is another embodiment of a decision-assistance system; and

FIG. 7 is a processing embodiment in a decision-assistance system.

### DETAILED DESCRIPTION

Many benefits are recognized when a user of one personal computing device participates in an interactive relationship with a user of another personal computing device. As users communicate with one another, the users learn more about each other to their mutual advantage. Users can share celebrations during happy times, grief during sad times, and other information representative of their particular emotional state. It is understood that sharing such information can have a therapeutic effect on both the users who post such information and the users who access such information. It has been recognized, however, that conventional social-networking systems are deficient in at least one aspect. That is, conventional social-networking systems lack any structured mechanism to help users make decisions.

The shortcoming of conventional social-networking systems lacking devices and methods to help users make decisions is addressed in the system described herein. The decision-assistance system discussed in detail herein implements a social network, or a portion of a social network, that helps users make decisions. Accordingly, the decision-assistance system may also be referred to as a “social decision network.” In some cases, the decision-assistance system (i.e., the social decision network) is a standalone system wherein users of the system are exclusive to the system, and most or all of the functionality of the system is directed toward a social network that facilitates decision making. In other cases, the decision-assistance system operates within a larger social network or a social network that provides other features not specifically directed toward decision making. In these cases, users may participate in decision-making activities using features of the decision-assistance system, but such users may also use the social network for other purposes.

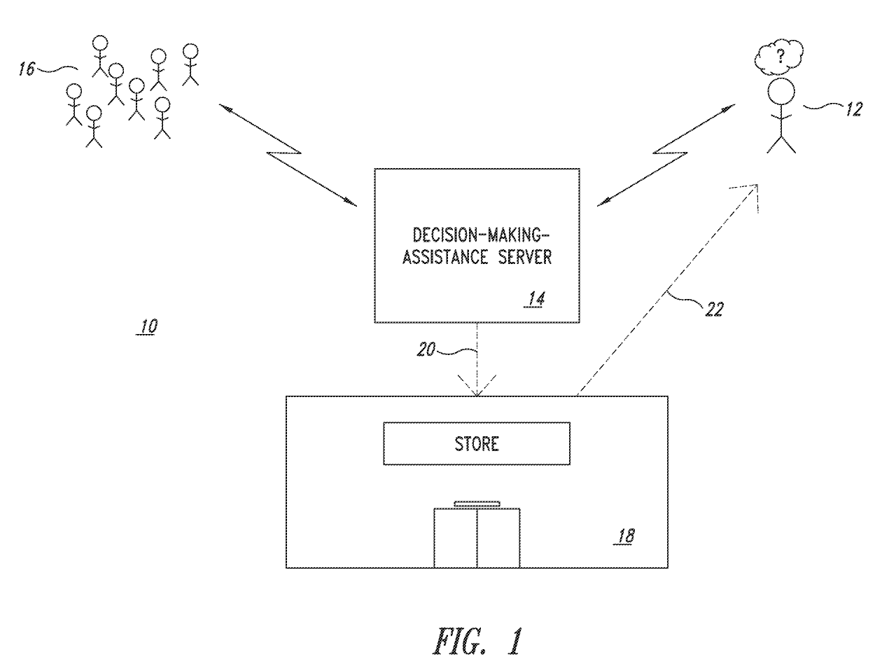

FIG. 1 is an embodiment of a decision-assistance system 10. A decision maker 12 accesses and passes a communication to a decision-making assistance server 14. The communication includes a subject of a decision that the decision maker is facing along with an action and at least two options or choices. For the exemplary embodiment, the subject of the communication is a refrigerator, the action is whether the decision maker should repair or replace her refrigerator, and two options are to repair the refrigerator and to replace the refrigerator.

In the present disclosure, the words “option” and “choice” may be used interchangeably. An option (or choice) represents one of the selectable results of a decision to be made. An option may be acceptable or not acceptable to a decision maker. A decision to be made may include a large and even infinite number of possible outcomes. For example, in the exemplary embodiment, the refrigerator could be replaced for $2,000. The refrigerator could be replaced for $1,500; the refrigerator could be successfully repaired for $400; the refrigerator could be unsuccessfully repaired for $400 wherein after payment of $400, the refrigerator is not fixed. Many other outcomes are clearly possible. With respect to the present disclosure, however, the decision maker provides a selected set of possible options that a decision adviser can review, rate, and comment on. Thus, it is understood in the present disclosure that “options” or “choices” that are associated with a decision to be made may be generated or otherwise approved by the decision maker and provided to one or more advisers, and in some cases, options or choices are generated as advice by one or more advisers and provided to a decision maker as advice in response to a decision to be made.

In the embodiment of FIG. 1, the decision-making assistance server 14 parses the communication into a set of constituent parts and identifies the subject, the action, and at least two decision options or choices. In some embodiments, the decision-making assistance server 14 suggests that the decision maker provide two to five options to improve the quantity and/or quality of advice. The decision-making assistance server 14 further analyzes the constituent parts, categorizes particular details, and stores the information. In addition, the decision-making assistance server 14 may optionally reformat the communication. The reformatting may include translation into one or more languages, providing a different sentence structure, or other changes to improve the readability and ease of understanding the decision.

The decision-making assistance server 14 presents the decision to be made to one or more advisers 16. The advisers 16 who receive the decision to be made can be selected randomly or purposefully by the decision maker 12. In some cases, the decision maker 12 expressly selects individual advisers to help with the decision, and in some cases, the decision maker 12 selects advisers 16 by their status as a member of some particular group (e.g., family members, close friends, experts in a particular subject matter, coworkers, parents of school-age children, etc.).

Each selected decision-assistance provider 16 reviews the decision to be made and indicates whether each of the decision choices mentioned is liked, disliked, or found by the adviser to be neutral, which the provider then communicates back to the decision-making assistance server 14. The decision-making assistance server 14 communicates some or all of the selected decisions back to the decision maker 12. In some cases, the decision-making assistance server 14 analyzes the advice received from the advisers 16 and ranks the choices being considered according to adviser indications received up to that time. The ranking of choices is communicated back to the decision maker 12. In other cases, the decision-making assistance server 14 may select a “top” choice, which can also be communicated back to the decision maker 12.

The optional “top” choice indicated by the decision-making assistance server 14 may be an aggregate of the opinions from the advisers 16. Alternatively, a “top” choice may be determined by an algorithm, may be selected randomly from the selected decisions communicated from the advisers 16, or the “top” choice may be determined by another method.

One or more businesses such as the business entity 18 illustrated in FIG. 1 may be interested in the decisions that people such as decision maker 12 are facing. In a complementary way, the decision makers may also desire certain business entities to know of the decisions the decision maker faces. As in the present exemplary embodiment, decision maker 12 may desire that business entity 18, an appliance repair and sales business for example, be aware of the failing refrigerator. In this way, decision maker 12 may receive help with the decision from her selected group of advisers 16 and she may also receive repair and sales information from business entity 18, which in this example is an appliance business.

When the decision-assistance system 10 of FIG. 1 is deployed, hundreds, thousands, and millions of people will be able to participate in the system as decision makers, advisers, or both decision makers and advisers. In this respect, certain ones of the decision makers will want business entities to be aware of the decisions that are to be made. The decision makers recognize a benefit from the experience and expertise of the business entities, and they may also receive other benefits such as favorable pricing (e.g., coupons, sales prices, and the like).

Business entities are interested in certain ones of the decisions that people face. For example, business entity 18 of FIG. 1 is typically interested in decisions that people face regarding matters of appliances. In the same way, business entity 18 is not likely interested in decisions regarding automobiles, relationships, job changes, or anything else that is not related to appliances. In addition, business entity 18 is also likely to be more interested in decisions related to the appliances that it sells and services than it is in other appliances. For example, if business entity 18 is a kitchen appliance store, it is likely very interested in decisions related to refrigerators, stoves, and dishwashers, and less interested in decisions regarding dental appliances (i.e., mouth-guards, braces, dentures, and the like), prosthetics (i.e., artificial limbs), and the like.

To address this desire of both decision makers and business entities, the decision-making assistance server 14 includes sophisticated analytical logic configured to parse natural language and determine the subject matter of a decision, the action(s) related to the decision, and decision choices being considered. From this data, the decision-making assistance server 14 includes additional analytical logic configured to group or otherwise consolidate decisions that share certain properties into “streams” of decisions. Turning to the exemplary embodiment of FIG. 1, business entity 18 may be interested in one or more decision streams related to appliances. Business entity 18 may thus subscribe to services provided by the decision-making assistance server 14 whereby it receives information related to decisions that regard appliances 20. Using the information, business entity 18 is able to contact decision maker 12 and provide information related to the decision about her appliance 22, which may include things like an offer to speak with an expert, a coupon, information regarding a current or coming sale, or other services.

The decision streams provided by the decision-making assistance server 14 may include many levels of granularity. For example, the business entity 18 may subscribe to all decision streams related to appliances or it may subscribe to decision streams related only to refrigerators, stoves, and dishwashers. Alternatively, or in addition, business entity 18 may subscribe to decision streams based on geographic area, demographic classifications of the decision makers, urgency, brand, or any other category that can be provided by the decision-making assistance server 14. In some cases, business entity 18 may subscribe to a plurality of decision streams, and the cost or terms of subscription may be any cost or terms that are agreeable.

The decision-assistance system described herein provides help making any kind of decision, from selecting what to have for breakfast to determining whether and where to have major surgery or how to make a major financial investment. Some embodiments may be narrowly focused, for example, what route should be driven at a specific time. In these types of narrowly focused cases, the decision-assistance system includes tools to increase efficiency and speed, for example, retrieval of a current location from a GPS system, acceptance of voice input for an address, and the like. Other embodiments are widely focused to let a user craft a request for help in making a decision regarding nearly any topic.

The decision-assistance system can also be used by businesses to receive timely alerts of decisions being made in their area(s) of interest. In this way, businesses may make beneficial use of new information regarding areas of interest of certain users.

Embodiments of the decision-assistance system described herein are directed toward users having any level of technical competence. The embodiments are sophisticated enough to address important dimensions of decision-making processes such as uncertainty and preferences. Nevertheless, the embodiments may shield the implementation of such complexity so that the decision-assistance system can be easily used by any person, whether or not they have any decision-related technical expertise.

Decision-assistance system embodiments described herein serve at least three distinct but interacting audiences: decision makers, decision-assistance providers, and businesses. Decision makers can include all users of the social-networking system. Decision-assistance providers are advisers that help others make decisions. Decision-assistance providers have incentives to provide decision-assistance that is considered valuable by the decision maker, because the decision maker can provide ratings that lead to some form of “points.” Points in the decision-assistance system can be redeemed for some consideration of value (e.g., software, services, money, or something else). Often, decision makers and decision-assistance providers are people. In some cases, however, a decision maker or decision-assistance provider is an entity such as a school, a business, a partnership, a team, or some other entity. Businesses generally include entities that offer products and/or services in exchange for money or some other consideration of value.

Within the decision-assistance system, a decision maker identifies a recognizable person or group that can be solicited for advice regarding a decision to be made. The solicitation for advice in some cases includes parameters such as a time frame, an expectation for a response, an indication whether shared advice will be made privately to the decision maker only or will be shared publicly for others in the group or even a wider audience, an expected level of detail in the advice, an expected amount of time that the person or group should devote to provide the advice, and others.

In such embodiments, the decision-assistance system facilitates an accurate description of one or more decisions for which help is requested. The particular description of the decision in whole or in part is made available to the business. Also in such embodiments, the decision-assistance system facilitates the request for advice, and in addition or in the alternative, the receipt of advice concerning the decisions. Information pertaining to such requests and such advice is made available in whole or in part to the business.

In one embodiment of the decision-assistance system, a decision maker describes a decision that needs to be made. The decision maker provides some context or parameters explaining the decision to be made and the choices being considered. The decision maker may also categorize the decision using either broad terms or very focused terms. The decision-assistance system may provide some help with the categorization by letting the decision maker choose from a volume of predetermined “themes,” which may otherwise be thought of as subjects, topics, fields, or the like. Alternatively, the decision-assistance system may analyze the incoming communication and automatically categorize the information in the communication into one or more themes. After the decision maker provides sufficient input, the decision maker will request help making the decision. The help may be requested from friends, colleagues, family members, or others. If certain people are organized by either the decision maker or by the decision-assistance system as belonging to a group, the decision maker can request from the group help making the decision.

In some cases, a decision maker directly invites friends, colleagues, family members or others to become a user of the decision-assistance system. The invited persons can each become a member of a user-defined group. The decision maker can form any number of groups, each with its own distinguishing name, and each assembling a selected set of members. Group membership may or may not be exclusive. That is, in a nonexclusive way, an individual can belong to any number of groups formed by one or more users. Correspondingly, a decision maker can create groups that share members.

The groups of users that provide advice to a decision maker may each include one or more members. Each group can be labeled by the decision maker, and each group may be known as an adviser group. In addition, each user that provides advice to a decision maker may be known as an adviser or a decision-assistance provider.

Some embodiments of the decision-assistance system permit one or more users with highly sought-after advice to be formed as an exclusive group. This exclusive group may provide advice exclusively to one decision maker, the group may provide advice only on certain topics, the group may provide advice only on certain days or at certain times, and the like. Other forms of exclusivity are also considered.

In some embodiments, an entity (e.g., a business) can purchase access to decision themes (e.g., life insurance, automobiles, restaurant choices, and many others). The theme-purchasing entity may then receive timely alerts to decisions being made that correspond to each such theme. Upon learning of a decision being made, the business can provide advice to the decision maker and, in doing so, can inform the decision maker of certain products and services that may be provided by the business. Such advice may be valuable to the decision maker.

As used herein, a decision theme may be defined by a set of words, including stems (e.g., roots) of words, synonyms, antonyms, and other related words, groups of words, and phrase structures. The set may be weighed by a probability indicating how likely a decision within the particular theme is to include or exclude a particular word, groups of words, or phrase structure.

Embodiments of the decision-assistance system described herein include a mechanism for a person or entity (e.g., a business) to join the social decision network as a user. Generally speaking, any person with network access (e.g., Internet access) and network accessible electronic contact information (e.g., an email address) can become a user of the decision-assistance system. A computing server maintains a profile for each user, and upon joining, a bare-bones profile may be instantiated for each user. The profile may include a username, a password, electronic contact information, geographic information, demographic information, and many other types of information. Where user-entered or otherwise-known information is not available, fields of the profile may include default information such as a default language, a “guest” status, a location based on an Internet Protocol (IP) address, and the like.

In some embodiments, when a user joins the decision-assistance system, the user supplies information for their associated profile via a personal computing device. The information may include name, email address, and password. The entry of information into a profile may include features meant to discourage or reduce the likelihood of automated user profile creation. One such feature, for example, may operate to distinguish a real human from an automated system (e.g., a CAPTCHA test). Prior to completion of a profile, and prior to registration as a user of the decision-assistance system, a prospective user may be required to accept certain terms and conditions of use, a privacy policy, and other like material. Over time, the user can enhance the user's profile by including photographs, demographics, a birth date, and other information. Entities (e.g., businesses, sports teams, schools, and the like) may include logos, photographs, one or more links to network resources such as a uniform resource locator (URL), a list of available products and services, contact information, and the like. Registered users of the decision-assistance system can invite other people or entities to become users of the decision-assistance system. Some embodiments facilitate a growing user base of the decision-assistance system by permitting users to send invitations right from the decision-assistance system.

In some embodiments, a user of the decision-assistance system can log in with the user's email address and password. In the embodiment, a forgotten password can be reset, but not recovered.

In some embodiments, the decision-assistance system provides features in multiple languages. For example, in one embodiment, the decision-assistance system is implemented in US English and Mexican/South American Spanish. The system is implemented with multilanguage capability. Other languages and dialects are also considered.

In some decision-assistance system embodiments, a user describes the decision to be made as text. The text can be entered with a keyboard, a voice-recognition feature, an image-recognition feature, a video-recognition feature, or some other functionality of a personal computing device. In one embodiment, the decision-assistance system allows the user to describe the decision to be made in up to 300 characters, but in other embodiments, different numbers of characters are permitted. In the same or a different embodiment, the decision to be made is labeled with up to 20 characters, which may be manually generated by the user or automatically generated by the decision-assistance system. Limiting the number of characters by which to describe or label the decision to be made can provide certain benefits, such as accessibility to certain communication media, likelihood of receiving a response, ability to display the entire text on the display of a mobile device, and other benefits. Accordingly, it has been recognized that providing such limitations may be advantageous in some embodiments.

In some embodiments, each decision label is unique for each user. Optionally, a user may include a more detailed decision definition. The more detailed definition can be used to increase clarity. In some cases, a decision label is used in whole or in part to sort information associated with a decision, to display such information, or to otherwise use such information.

In some embodiments, a decision maker is soliciting advice broadly and without limitation. In some embodiments, a decision maker provides two choices for users to select from. Other embodiments permit three choices, five choices, and up to ten choices or some other number. Limiting the number of choices and/or limiting the range of choices may be advantageous. For example, it has been recognized that when a decision maker frames a decision to be made such that advisers give opinions regarding a choice from a pool of two or three choices, the response rate increases and the time to respond decreases.

Embodiments of the decision-assistance system may optionally permit a user to add context (i.e., hopes and/or concerns) to any decision to be made. Context is added by entering text via an input of the personal computing device. The entered text may complete a canned system phrase such as, “I hope . . . ”, “I worry . . . ”, and others. Some hope and/or concern phrases are singular (e.g., “I worry . . . ”), and other hope and/or concern phrases are plural (e.g., “We worry . . . ”). Hope and/or concern phrases are optional and may not be required in some embodiments. Hope and/or concern phrases can be deleted. In some embodiments, it has been recognized that decision makers prefer to choose a small number of hope and/or concern phrases, such as two or three, issues of their choice. In some embodiments, the number of permissible hope and/or concern phrases is limited to a certain threshold, for example, no more than half a dozen. Placing limitations on the number of hope and/or concern phrases may be advantageous across the system, amongst a certain demographic, when personal computing devices are located in a certain geographic area, and the like. Hope and/or concern phrases can in some cases provide a more efficient way to express uncertainties, preferences, and other attributes of decisions to be made without requiring mathematical rigor.

Embodiments of a decision-assistance system form a classification database of categories of decisions to be made. The database may include features that permit the database to expand when new categories are added. The database may include features that permit the database to contract when some categories are removed. Categories may be merged or separated over time due to how frequently decision assistance is requested, how changes or nuances in the language or culture evolves, or for other reasons. A decision maker in some embodiments is permitted to classify each decision by selecting a category from the database. In some cases, a decision maker may believe that a decision to be made should be associated with more than a single category. The decision maker in some embodiments can include, for example up to three, additional categories. In some of these embodiments, when a decision to be made is associated with a plurality of categories, each category is weighted by a respective percentage such that the sum of percentages is 100%. The decision maker, the one or more advisers (i.e., users from whom advice is sought), or a feature within the decision-assistance system may assign or adjust the weightings.

In embodiments of the decision-assistance system, a decision maker generates a description of the decision to be made. The description may include the choices under consideration and may also include appropriate hope and/or concern phrases, categories, and other parameters. After the description is formed, the decision maker can request advice from an individual user or a group of advisers.

A request for advice can be made to users of the decision-assistance system (i.e., the social decision network). Advice can also be requested from one or more people via other social networks such as (FACEBOOK, LINKEDIN, GOOGLE+, TWITTER, and the like), via email, or in some other way. In some cases, the advice requested and communicated is substantive and delivered in the form of phrases, sentences, paragraphs, and the like. In other cases, the advice requested and communicated is delivered for each choice in the form of a vote or even a simple LIKE, DISLIKE, or NEUTRAL.

Advice regarding the decision to be made is received by the decision maker. In some cases, the advice includes, in whole or in part, for each choice a semaphore vote. In one embodiment, the vote may be delivered as a color. For example, GREEN=like, YELLOW=neutral, unsure, or unclear, and RED=dislike.

Advisers may in some cases be required to or optionally be permitted to add words, phrases, sentences, paragraphs, and the like as commentary. The commentary is made available to the decision maker and can be presented via a personal computing device associated with the decision maker.

In some cases, adviser groups act as a single unit permitted to communicate an overall semaphore vote (e.g., green, yellow, red) for each choice. In some cases, the individual members of the adviser group may communicate individual semaphore votes. Along these lines, individual members of an adviser group or the adviser group as a unit may, or may not, be permitted to communicate commentary regarding the decision to the decision maker. In other embodiments, percentages of group responders are available to the decision maker. Multitudes (i.e., crowds, large groups of unidentified people) can also vote (e.g., green, yellow, red) and individuals who form part of a multitude may or may not be permitted to provide comments. Advice from multitudes can be reported in terms of semaphore votes (e.g., per green, per yellow, per red), and number of respondents per semaphore color.

Upon receiving advice, decision makers may have the opportunity to grade the received advice. The grading produced by the decision maker may be specific to the advice received from one adviser. Alternatively, or in addition, the grading may be directed to advice received from a group of advisers.

In one embodiment, a decision-assistance system includes a feature of points and credits. With respect to points in this embodiment, upon receiving decision advice from one or more advisers, a decision maker grades the adviser's advice. The advice may be graded according to any selected mechanism, such as a norm-referenced system, a criterion-referenced system, a peer-evaluation, or some other scale. In one system, advice may be graded as USELESS, OK, USEFUL, or BRILLIANT. In the embodiment, the adviser who provided the graded advice receives decision-assistance system points for each graded response, as illustrated in Table 1. An exemplary association of points and credits is described later.

TABLE 1

| Grade | Points |
|---|---|
| USELESS | 0 points |
| OK | 1 point |
| USEFUL | 3 points |
| BRILLIANT | 10 points |

As described herein, embodiments of a decision-assistance system include a classification database of categories of decisions to be made. In some embodiments, a decision maker's category for a certain decision to be made can be combined with a Naïve Bayes or other learning and detection algorithm. The results of the combination may yield one or more decision-assistance system categories or themes.

Within the decision-assistance system, themes are structures that represent recognized decisions of certain types that may be of interest to particular users (e.g., business users). A theme is a group or set of words including roots of words, synonyms, antonyms, and other related words or groups of words, stems (roots) of words, and phrase structures that probabilistically occur in decisions to be made having a particular type.

For example, a theme entitled, “Life Insurance,” can be formed with insurance-related terms such as “insurance,” “premium,” “term,” “whole,” “universal,” “beneficiary,” and the like as well as with phrase structures such as “whole life” and/or “universal life.” Each term and phrase structure may have its own probability of occurrence. Related words, therefore, such as “insurance,” “insured,” “Insure,” and “insurability,” may be represented by the single stem (i.e., root) “insur.” One advantage of combining words in this and similar ways is to reduce the size of each theme as stored in memory. Frequencies are deduced from algorithmic exposure to positive and negative training examples. As the decision-assistance system database of decisions to be made grows and, consequently, the number of decision examples increases, the Naïve Bayes algorithm improves, and the themes become better at identifying and distinguishing decisions.

Decision themes identify topics (e.g., ideas, subjects, concepts, and the like) in a decision to be made wherein the topics are likely related to the subject matter of the theme. Users (e.g., business users) can request access to decision streams based on themes. For example, a business can subscribe to a theme, which yields a “stream” of decisions from which the business can identify leads and other opportunities. For example, a university can subscribe to a theme yielding a stream of decisions related to prospective students. A user can purchase access to a theme and a resulting stream of decisions related to a topic they find relevant as well. Other users can purchase access to a theme that yields a stream of decisions for any other reason too.

Subscription to decision themes can be structured in any way. For example, subscription to a decision theme can be structured to reflect any particular price, any particular time frame, any particular geographic boundaries, any particular demographics, and any other criteria.

In some cases, access to a decision theme can be made in whole or in part based on “credits.” In some embodiments, credits are purchased (e.g., via credit card, electronic funds transfer, electronic currency, etc.). The price of each credit may be fixed or the price may be dynamic based on demand or other economic and noneconomic parameters. In these or other embodiments, a user may also purchase or otherwise receive credits using a currency based on advice “points.” As described previously, points may be accumulated by providing advice that is found to be valuable by a decision maker in response to a request for help in making a decision.

In some embodiments, each point may be valued to one credit, a partial credit, or multiple credits. The association between points and credits can be fixed or can change based on a variety of economic and noneconomic conditions.

In some embodiments, purchased credits are indistinguishable from granted credits (i.e., credits granted from decision maker grading of adviser-provided advice to others). Credits may be accumulated in one or more accounts associated with a user. A user may withdraw credits from their associated account to purchase access to decision themes and their corresponding decision streams, segmented based on geographic, demographic, timing, and other criteria, as requested.

The decision-assistance system may include simplified versions of one or more decision-making tools. These tools can assist decision makers. These tools have been adapted from more complex tools that have a strong track record of success in the decision-consulting field.

In some embodiments, users are granted access to the tools based on their use of the decision-assistance system. In other embodiments, access to the tools is based on a fee paid. In yet other embodiments, the tools are freely available to users. And in still other embodiments, the tools are restricted in some other manner. For example, in one case, some or all of the tools become available based on an amount of revenue generated by the decision-assistance system. In another case, the tools become available based on how many users gain access to decision themes and corresponding decision streams.

Some examples of tools that may optionally be incorporated into the decision-assistance system include: decision hierarchies, decision tables, decision diagrams, decision-quality (DQ) measure diagrams, and a list of common decision traps. Decision traps may be coupled with a suggestion for avoiding them or, at least, mitigating their effects. Other tools might include decision trees, probability assessment instruments (simple and advanced), valuation templates, and the like.

In a decision hierarchy, a decision to be made is viewed as being “sandwiched” between previously made “given” decisions, which are not being challenged, and “associated” decisions that can be made separately from, and usually after, the subject decision(s) to be made (i.e., the focus decision(s)). Given decisions enable or constrain the decision(s) being made (i.e., the focus decision(s)) and are decisions that will not be challenged when the focus decision(s) are made. Associated decisions are decisions that can be made separately from the one or more focus decisions. In other words, the decision hierarchy operates in the context of previous decisions and their association to a focus decision to be made, and based on the focus decision to be made, the decision hierarchy recognizes associated decisions that are related to one or more focus decisions and can be made separately from such focus decision(s). In this way, a decision hierarchy is a tool that can be used to help a decision maker articulate the specific decision to be made and its context.

A decision table is used to formulate alternative choices for a decision to be made. It has been recognized that a good decision is made with two to a handful of choices that are: 1) mutually exclusive, 2) substantially different from one another, 3) attractive to the decision maker, 4) feasible by the decision maker and/or by any individuals and/or groups responsible for executing the actions implied by the selected choice, and 5) “ballistically” defined (i.e., defined with sufficient detail that the decision maker or a designated team could execute them with little or no additional guidance if the choice were preferred over other choices). Such a tool can be provided to decision makers along with guidance to help generate appropriate entries for the table.

A decision diagram is a tool that a decision maker can use to prepare and display simple bubble-and-arrow pictures that concisely represent a decision—no matter how complex—within the space of a single page or display window. In the bubble-and-arrow picture, a decision-making process is depicted as a decision to be made along with the decision's alternative choices, uncertainties, and valuation (e.g., preferences and trade-offs). Although more complex versions of bubble-and-arrow tools are known, it has been recognized that simple, one-page diagrams generally facilitate good decisions within the decision-assistance system.

Within the decision-assistance system, two formats of decision quality (DQ) diagram formats may optionally be included. In a first DQ diagram format, a six-spoke radar plot is generated. In a second DQ diagram, an antenna or flagpole plot with seven to twenty antenna “poles” is generated. The six-spoke radar plot depicts the six DQ dimensions that are often considered essential: 1) Frame, 2) Alternatives, 3) Valuation, 4) Predictions, 5) Reasoning, and 6) Commitment. The antenna plot includes other dimensions in addition to those of the six-spoke radar plot. Some of the optional, context-dependent, dimensions in the antenna plot (i.e., flagpole diagram) include: 7) Information, 8) Decision Fitness, 9) Ethics, 10) Timing, 11) Risk, 12) Refinement, 13) Challenge, and possibly other like dimensions.

A list of names and brief descriptions of common decision traps can help a decision maker recognize traps and take steps to avoid a trap or mitigate its effects. Accordingly, the decision-assistance system may include a tool that organizes a list of decision traps and, thusly, provides guidance to a decision maker. In some embodiments, traps are grouped in different categories, for example, “individual,” “large organization,” “medical,” “government,” and “perverse.” Perverse traps are those that apply to decision makers in any context. Other categories may also be included. Sample trap names might include: “Going to Abilene,” “Jack Attack,” “Group Think,” “Sledge-hammer Decisions,” and “Buridan's Burro.” Other trap names may also be included.

One embodiment of a complete decision-assistance system is configured according to the outline presented in Table 2.

TABLE 2

| 1. | Purposes | |
|---|---|---|
| | 1.1. | Help users make decisions and get advice |
| | 1.2. | Provide (business) users the ability to identify and be alerted to |
| | | decisions in their area(s) of interest and in their target demographics |
| | 1.3. | Provide tools for decision makers to improve their decisions |
| 2. | System Characteristics | |
| | 2.1. | Languages: English, Spanish, and others |
| | 2.2. | Overall Structure |

| | |
|---|---|
| 2.2.1. | Decision Statement and Advice |
| 2.2.2. | Theme Purchase and Use |
| 2.2.3. | Decision Tools |

| 3. | Access | |
|---|---|---|
| | 3.1. | Registration |

| | |
|---|---|
| 3.1.1. | 1^{st} Name, Middle Name, Last Name(s) |
| 3.1.2. | Email Address |
| 3.1.3. | Demographics |

| | |
|---|---|
| 3.1.3.1. | Birth Date |
| 3.1.3.2. | City (Home, Work) |
| 3.1.3.3. | State (Home, Work) |
| 3.1.3.4. | Country (Home, Work) |

| | |
|---|---|
| 3.1.4. | Email-address Validation |

| | |
|---|---|
| 3.1.4.1. | Only users c validated email addresses can store decisions, invite |
| | advisers, create groups, and request advice. |

| | |
|---|---|
| 3.1.5. | Business Profile - Extension |

| | |
|---|---|
| 3.1.5.1. | Contact (Name, Data) |
| 3.1.5.2. | Phone Numbers |
| 3.1.5.3. | Address |
| 3.1.5.4. | Products/Services (List) |
| 3.1.5.5. | Expertise |
| 3.1.5.6. | Target Geography |

| | 3.2. | Login |
|---|---|---|
| | 3.3. | Invitations to Join (via email; within the system) |
| | 3.4. | Password Reset |
| 4. | Decisions | |
| | 4.1. | Specification |

| | |
|---|---|
| 4.1.1. | Label (optional) |
| 4.1.2. | Description |
| 4.1.3. | Details |
| 4.1.4. | Keep Confidential (Advice can only be obtained from individuals.) |

| | |
|---|---|
| 4.2. | Choices (2 to 10) |

| | |
|---|---|
| 4.2.1. | Suggest: Mutually Exclusive |
| 4.2.2. | Description and details |
| 4.2.3. | Advantages |
| 4.2.4. | Disadvantages |

| | |
|---|---|
| 4.3. | Hopes and Concerns (context) |

| | |
|---|---|
| 4.3.1. | I/We Hope: . . . |
| 4.3.2. | I/We Worry: . . . |
| 4.3.3. | Timing Constraints (e.g., Deadlines) |
| 4.3.4. | Other considerations |

| | |
|---|---|
| 4.4. | Categories (0 to 4 from a long list) |

| | |
|---|---|
| 4.4.1. | Action |
| 4.4.2. | Subject |
| 4.4.3. | Weights |

| | |
|---|---|
| 4.4.3.1. | Default: Equal Weights |

| 5. | Advisers | |
|---|---|---|
| | 5.1. | Individuals |
| | 5.2. | Groups |
| | 5.3. | Multitudes (Crowds) |

| | |
|---|---|
| 5.3.1. | E.g., Facebook, Linkedln, Twitter, Google+ |

| 6. | Grading | |
|---|---|---|
| | 6.1. | Every piece of advice can be graded by the decision maker |

| | |
|---|---|
| 6.1.1. | Not Useful (Points: 0) |
| 6.1.2. | Useful (Points: 1) |
| 6.1.3. | Very Useful (Points: 5) |
| 6.1.4. | Brilliant (Points: 10) |

| | 6.2. | Good (highly graded) advice can yield credits |
|---|---|---|
| 7. | Credits | |
| | 7.1. | Purchased (ecommerce, e.g., via Pay Pal) |

| | |
|---|---|
| 7.1.1. | Credits are dynamically priced (Manually) |
| 7.1.2. | Themes are dynamically priced (Algorithmically, TBD) |

| | |
|---|---|
| 7.2. | Earned (via highly graded advice) |

| | |
|---|---|
| 7.2.1. | 50 points = 1 Credit (may change) |

| 8. | Decision Themes | |
|---|---|---|
| | 8.1. | From user-specified categories |
| | 8.2. | From auto detection (Text Recognition) |
| 9. | Text Recognition | |
| | 9.1. | Naïve Bayes |

| | |
|---|---|
| 9.1.1. | Training: User-defined categories |

| 10. | Decision Tools | |
|---|---|---|
| | 10.1. | Decision “Stethoscopes” - a stethoscope is a very simple tool that, with the |
| | | appropriate skill, can be used to quickly generate great value. |

| | |
|---|---|
| 10.1.1. | Decision Hierarchies |
| 10.1.2. | Decision Tables |
| 10.1.3. | Bubble-&-Arrow Diagrams |
| 10.1.4. | Decision Traps (Identify and Correct) |

| | |
|---|---|
| 10.2. | Journeyman Tools |

| | |
|---|---|
| 10.2.1. | Tornado Diagrams |
| 10.2.2. | Valuation Coaches |
| 10.2.3. | Valuation Templates |
| 10.2.4. | Simple Probability-assessment Tools |

| | |
|---|---|
| 10.2.4.1. | Bars, 10-90-50 |
| 10.2.4.2. | Simple conditioning |

| | |
|---|---|
| 10.2.5. | DQ Measure |

| | |
|---|---|
| 10.3. | Master Tools |

| | |
|---|---|
| 10.3.1. | Conditional Ranges |
| 10.3.2. | Probability Wheel and Assessment Chart |
| 10.3.3. | Relevance and Decision Diagrams (Quantitative) |
| 10.3.4. | Distribution Trees |
| 10.3.5. | Risk-tolerance Assessment |

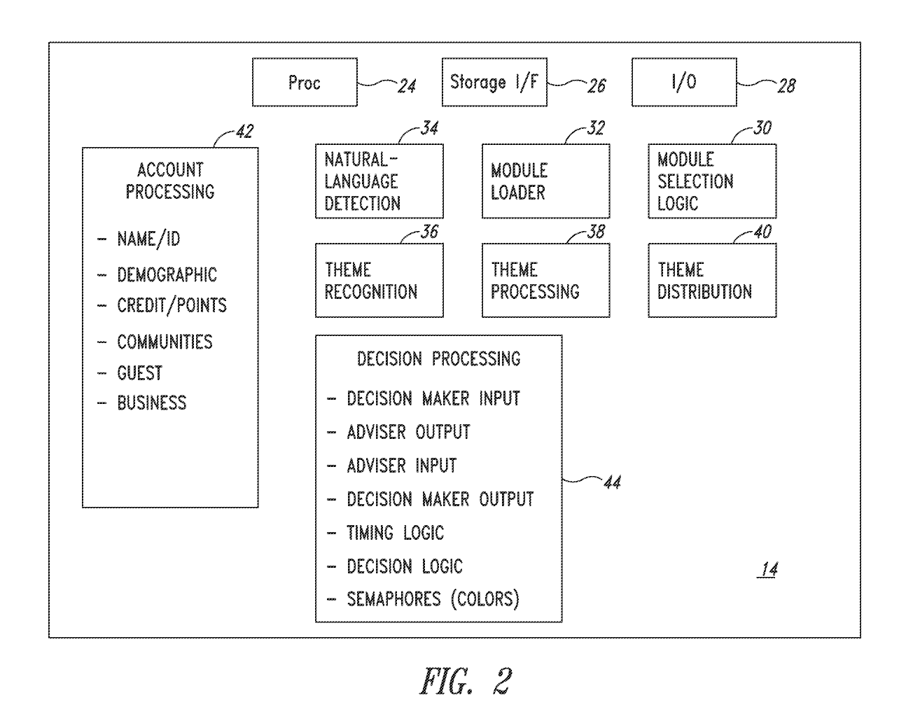

FIG. 2 is an embodiment of a decision-assistance server 14 illustrated in FIG. 1. The decision-assistance server 14 may include hardware structures of a computing server, a super computer, a server farm, or the like. A processor module 24 executes computing software instructions. The computing instructions may be accessed via a storage interface module 26. The storage interface module 26 may include one or more memory modules. Alternatively, or in addition, the storage interface module 26 may be coupled to one or more local or remote external memory storage devices. An input/output (I/O) module 28 passes information to and from the decision-assistance server 14. For example, keyboard input, mouse input, and programmatic control information may be passed from outside into the decision-assistance server 14. Display information, audio information, and other information may be passed outside from inside the decision-assistance server 14 via the I/O interface 28.

The decision-assistance server 14 includes a plurality of modules to implement the decision-assistance functions. Various embodiments may include all of the modules of FIG. 2, and other embodiments may include only a subset of the modules. Module-selection logic 30, which may include a finite-state machine, recognizes a flow of processing through the decision-assistance server 14. The module-selection logic 30 determines which module will process various input and output information. A module loader 32 is used to enable processing of modules within the decision-assistance server 14 as selected by the module-selection logic 30.

A natural-language-detection module 34 detects analyzable text-based word objects within human language and parses the incoming information into its constituent parts, and a set of theme operations modules processes theme information. The theme operations modules optionally include a theme-recognition module 36 that determines themes present amongst input information from a user of the decision-assistance server 14, a theme-processing module 38 that draws additional information associated with the recognized themes, and a theme-distribution module 40 that sends information associated with the recognized and processed themes to entities that have subscribed to receive such themes. The theme-operations modules may be separately identifiable as illustrated in FIG. 2, separated into more modules, or consolidated into fewer modules. The decision-assistance server 14 also includes an account-processing module 42 to process user-related features and a decision-processing module 44 to process decision-related features.

Module-selection logic 30 is configured to monitor and process a plurality of decision streams. In this context, a single decision stream may be considered to include input information from a decision maker regarding a decision to be made, processing of the information associated with the decision to be made, presentation of the information to one or more advisers, collection of advice from the one or more advisers, and presentation of results back to the decision maker. In some embodiments, the module-selection logic 30 may comprise a finite-state machine for each individual decision stream. In other embodiments, the module-selection logic 30 may comprise a finite-state machine for a plurality of decision streams associated with a same decision maker. In still other embodiments, the module-selection logic 30 may comprise a finite-state machine for a plurality of decision streams that share a common theme. Different embodiments of the module-selection logic may not use a finite-state machine at all.

In processing a decision stream, the module-selection logic 30 manages which logic modules of the decision-assistance server 14 will execute functions to receive information, process information, present information, share information, and store information. The order in which particular modules are loaded and called is directed by the module-selection logic 30 in cooperation with the module loader 32.

Embodiments of the module loader 32 enable processing of modules within the decision-assistance server 14 as selected by the module-selection logic 30. The module loader 32 cooperates with the storage interface 26 to load and unload particular functions and algorithms that are executed by the processor 24. The module loader 32 may include antihacking security features to avoid compromising confidential data of the decision-assistance system 10 (FIG. 1),

A natural-language-detection module 34 detects text-based word objects within human language and parses incoming information into its constituent parts. In some embodiments, the decision-assistance system 10 operates as a social network to help users make decisions. A decision to be made is presented with a subject, and action, and a set of possible choices. The decision maker uses the decision-assistance system 10 to receive advice indicating each adviser's opinion of each choice being considered. A decision maker may provide subject-matter information associated with the decision to be made, the implied action(s), and the choices being considered by keying text data into a computing device, speaking into an audio-input system of a computing device, passing still-image or video data into a computing device, or via some other means. The natural-language-detection module 34 may comprise hardware and software logic such as a human interface device (HID), microphone, and camera, along with digital signal processing logic, to turn the input information into one or more strings of text characters. The natural-language-detection module 34 is configured to identify and parse text strings into constituent parts.

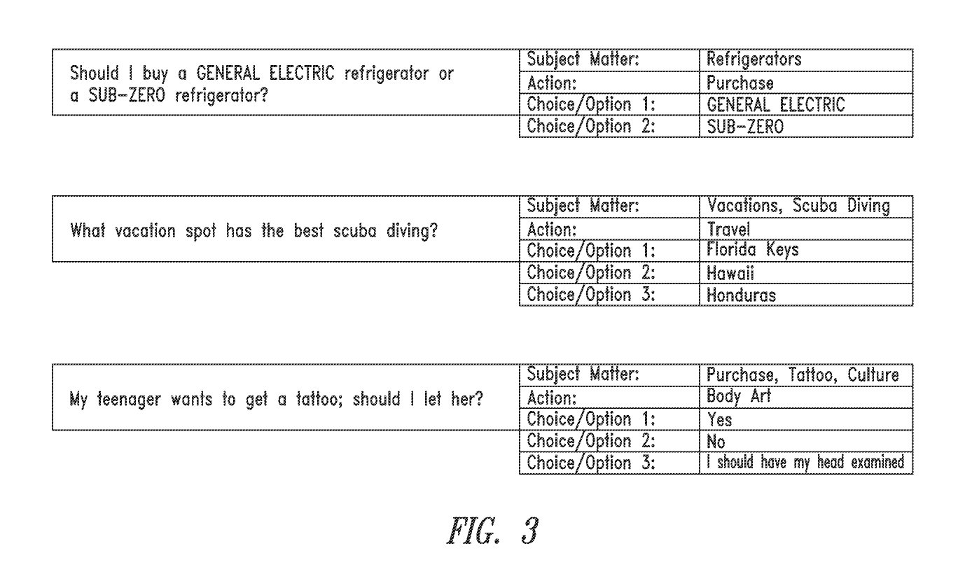

FIG. 3 illustrates natural-language-processing analyses performed by an embodiment of a natural-language-detection module 34. As shown in FIG. 3, strings of text are formed by the natural-language-detection module 34. Hardware and software, which may optionally include text-input logic, audio-processing logic, image-processing logic, multiprocessor logic, artificial intelligence, and the like, processes input from a decision maker to form the strings of text illustrated in FIG. 3. In one embodiment of the natural-language-detection module 34, the exemplary text strings in FIG. 3 are each formed as a single sentence ending with a question mark (“?”).

Although the text-string questions in FIG. 3 are generally short and direct, it is recognized that user input may form very long questions having compound subjects, multiple actions, and a large (e.g., more than 5) number of choices. In some embodiments, the natural-language-detection module 34 will simplify complex questions into a plurality of questions having a smaller number (e.g., one or two) of subjects and a smaller number (e.g., one or two) of actions. The natural-language-detection module 34 is arranged to access one or more semantic nets, which show the relation of word types to other word types in a sentence, and one or more dictionaries such as thesauri dictionaries, etymological dictionaries, phonetic dictionaries, dialect dictionaries, ideographic dictionaries, personal- and place-name dictionaries, phrase dictionaries, slang dictionaries, idiomatic dictionaries, quotation dictionaries, grammatical dictionaries, conversational dictionaries, linguistic dictionaries, and the like.

Algorithmic processing within embodiments of the natural-language-detection module 34 iteratively process the text strings. In some cases, individual words in the text strings are processed and replaced recursively or iteratively with suspected synonymous words until patterns are detected in which particular word roots are identified. For example, in FIG. 3, a first formed question is associated with a purchase of a particular refrigerator. In this case, the natural-language-detection module 34 has recognized that the word “buy” is synonymous with the word “purchase.” The natural-language-detection module 34 may have detected word input and, in addition or alternatively, processed other synonymous and similar words and word combinations such as “invest in,” “pay for,” “acquire,” “shop for,” “procure,” “get,” and the like. The natural-language-detection module 34 embodiment has formed the refrigerator question as illustrated in FIG. 3.

In the refrigerator embodiment of FIG. 3, the natural-language-detection module 34 has identified a single word subject of the decision to be made, “Refrigerators.”

In the refrigerator embodiment of FIG. 3, the natural-language-detection module 34 has identified a single word action of the decision to be made, “Purchase.”

In the refrigerator embodiment of FIG. 3, the natural-language-detection module 34 has identified two choices, “GENERAL ELECTRIC,” and “SUB-ZERO.”

Two additional cases of the natural-language-detection module 34 embodiment processing are also illustrated in FIG. 3. In the scuba-diving embodiment, the natural-language-detection module 34 has parsed and determined two subjects, “vacations” and “Scuba Diving;” determined a single action, “Travel;” and determined three choices, “Florida Keys,” “Hawaii,” and “Honduras.” In the tattoo embodiment, the natural language-detection-module 34 has parsed and determined three subjects, “Purchase,” “Tattoo,” and “Culture”; determined a single action, “Body Art”; and determined three choices, “Yes,” “No,” and “I should have my head examined.”

From the examples of FIG. 3, it is recognized that in some cases, a decision maker may enter well-formed questions that present clear subject matter, action, and choices. In these cases, the natural-language-detection module 34 may produce a decision to be made entirely or substantially from the input provided by the decision maker. For example, in the refrigerator embodiment, a decision maker may have entered the exact question illustrated in FIG. 3.

In other cases, however, a decision maker may enter a decision to be made with less clarity. For example, in the scuba diving embodiment, a decision maker may have entered text as presented in Table 3, and in the tattoo embodiment, a decision maker may have entered text as presented in Table 4.

TABLE 3
“I went diving in Honduras and I loved it, but now I can't decide whether
I should go back to Honduras, or try Hawaii or the Florida Keys.”
“The scuba diving magazines that I read say that the top three places to
dive in the world are the Florida Keys, Hawaii, and Honduras, but what do
you think?”
“Help me decide where to go on my next diving vacation: Hawaii,
Honduras, or the Florida Keys.”

TABLE 4
“Anna is 15 and is asking me to buy her a tattoo. Would I be crazy to
do it?”
“Amy wants to be inked, but she's only 17 and needs my permission;
I would be insane to let her, right?”
“What kind of parent lets their 13-year-old daughter get a face tat?”

The natural-language-detection module 34 is arranged with advanced analytical logic configured to parse natural language. The module-selection-logic module 30 in the module loader 32 allows any number of libraries to be dynamically loaded such that natural language from teenagers to senior citizens may be understood and parsed. In addition, the natural-language-detection module 34 can recognize and form decisions to be made as simple questions such as what to have for dinner to complex questions such as where to have major surgery and anything else that decision makers can come up with.

In some embodiments, the natural-language-detection module 34 forms questions that will be presented to one or more advisers (e.g., such as those of FIG. 3), and presents the questions back to the decision maker for review. In these embodiments, the decision maker may accept the question or questions as formed by the natural-language-detection module 34, or the decision maker may edit a presented question or delete it.

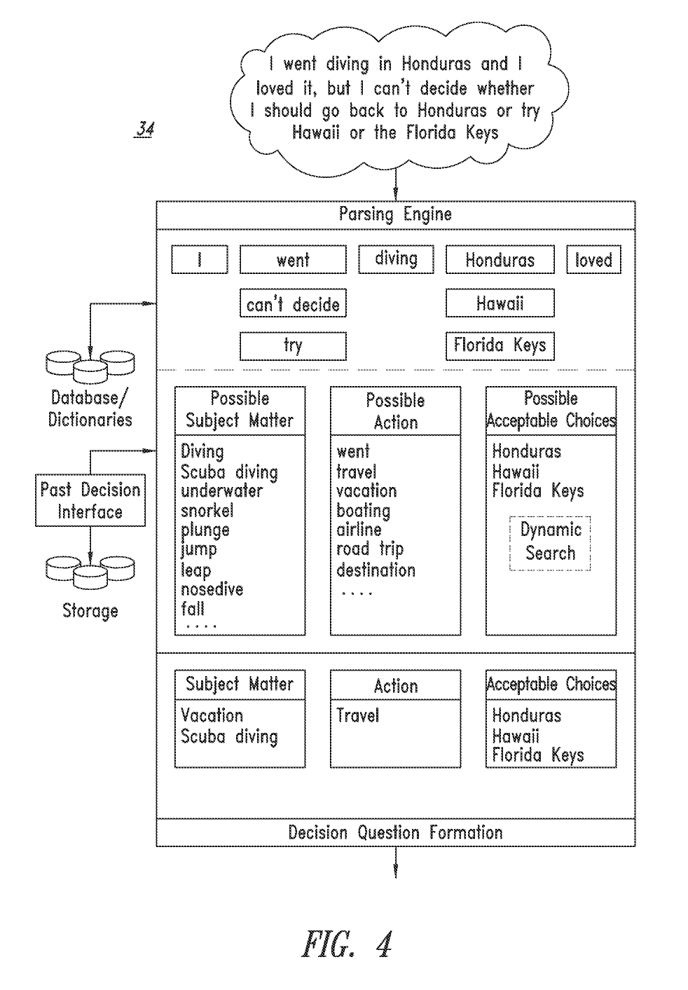

FIG. 4 is an embodiment of a natural language processing algorithm carried out by the natural-language-detection module 34. In the figure, a hypothetical input of the scuba-diving embodiment is processed. A scuba-diving statement is input into the natural-language-detection module 34. The input may be typed in, keyed in, spoken, or presented as an image or video into the decision-assistance system 10.

A parsing engine portion of the algorithm distinguishes individual words or word combinations from the input. In some cases, the parsing engine distinguishes different grammatical portions of the input. For example, personal pronouns may be grouped together and verbs may be grouped together; and similar grouping may be performed for nouns, proper nouns, adjectives, and other recognized parts of speech. In some cases, the algorithm may place certain words or word combinations in multiple groups.

In a next phase of processing, the natural-language-processing algorithm iteratively and/or recursively analyzes the individual words and word groups to determine possible subject matter, possible actions, and possible choices for a decision to be made. The algorithm may optionally include artificial-intelligence processing to predict word combinations and intent of the decision maker. The algorithm may draw input from a plurality of databases and dictionaries. In some cases, the databases and dictionaries are static and accessible to the natural-language-detection module 34, and in additional or alternative cases, the databases and dictionaries are dynamically accessible via the Internet or another wide-area network. The natural-language-processing algorithm may additionally access a growing and changing database of past decisions processed by the decision-assistance system 10. A past-decision interface is illustrated in FIG. 4. In some cases, the past-decision interface is part of the natural-language-detection module 34; in other cases, the past-decision interface includes separate algorithmic processing to programmatically form desirable database queries.

After forming at least one but often a large plurality of “possible” data directed to the subject matter and possible action of the decision to be made, and after forming at least two but often a large plurality of “possible” choices for the decision to be made, the natural-language-processing algorithm selects proposed subject matter, proposed action, and proposed choices. The selection may be based on statistical analysis, a weighted analysis, or another type of analysis.

After the selection of subject matter, action, and at least two choices, a Decision Question Formation portion of the algorithm will prepare a grammatically-correct sentence in the form of a question. The generated question, which presents the decision to be made, is then communicated to the decision maker for review. The decision maker may accept the question as formed by the natural-language-detection module 34 or the decision maker may reject the question. If the decision maker rejects the question, the decision maker may edit the question in a desirable way. In addition, or as an alternative, the decision maker may override the question produced by the natural-language-detection module 34 and draft an entirely new question. In some cases, the natural-language-detection module 34 includes one or more software wizards to assist or otherwise coach the decision maker in drafting a suitable decision to be made into a question.

An account-processing module 42 manages guest, user, and business accounts as well as other account functions within the decision-assistance server 14. Additional modules, which may include submodules and portions of modules, are included within the functionality of the account-processing module 42. For example, the account-processing module 42 may optionally include a name/identification module, a demographic module, a credit/points module, a communities module, a guest module, and a business module.

The account processing module 42 provides an interface through which users may access the decision-assistance system 10 of FIG. 1. In the embodiment of FIG. 2, users can access functions of the decision-assistance server 14 anytime from anywhere in the world using a computing device such as a desktop computer, a laptop computer, a tablet, a smartphone, or any other computing device configured to access a network such as the Internet.

As a user becomes familiar with the system, the user may access additional capabilities of the system. For example, the user can give a rough idea of a decision's context, invite people to join a personal network, and ask specific individuals for advice. The user can create groups of advisers (neighbors, colleagues, family, etc.) and ask one or more of the groups for advice.

The name/identification module of the account processing module 42 is generally directed to front-end and back-end processing associated with users that access the decision-assistance system 10. In some embodiments, the decision-assistance system 10 may be accessed by registered users (i.e., people having an account) and unregistered users (i.e., guests). People can access the decision-assistance system 10 via a wide-area network such as the Internet. Registered users may be decision makers, advisers, or entities (i.e., people, businesses, governments, or other organizations) seeking to access streams of decisions. Unregistered users may be decision makers; however, in some embodiments unregistered users may also provide advice or be permitted to access decision streams.

A registered user may form an account with the decision-assistance system 10. Optionally, the account may be accessed with a username, email address, password, personal identification number (PIN), or in many other ways. Embodiments of the decision-assistance system 10 use the account information to recognize previous decisions to be made, advice provided, decision streams accessed, and other information. Recognition of such information generally improves a user's experience by prepopulating information fields and providing an accurate history of use which a user may want to review. In addition such information may keep track of points earned, payments made, and other information stored on behalf of the registered user.

In some cases, a registered user may also submit other information generally associated with social networks. For example, the information may include first name(s), middle name(s), last/family name(s), a public nickname, a birthday, a birth year, gender or gender preference, one or more photographs, a profession or job title, place of employment, electronic mail preferences, and the like. In some cases, a geographic location is provided by the registered user. In addition, or in the alternative, a network address such as an Internet Protocol (IP) address is used to verify or determine a geographic location.

A public nickname refers to a pseudonym used by decision-assistance system 10 users when they ask for or provide advice. In some embodiments, when a public nickname is not specified, first and last names may be used instead. Public nicknames are unique within the decision-assistance system 10. In some embodiments, if a user selects an already-existing public nickname, the decision-assistance system 10 automatically offers an alternative nickname comprising the requested nickname followed by one or more additional ASCII characters.

In some cases, a user must pass a Completely Automated Public Turing Test to tell Computers and Humans Apart (CAPTCHA) to enter information. A CAPTCHA or other gateway may be used to thwart programmatic entry of data and thereby promote desirable social networking. Along these lines, in some embodiments of the decision-assistance system 10, a user may also register or log in using the credentials of another social or business networking website such as FACEBOOK or LINKEDIN.

In some embodiments, the account-processing module 42 permits a user to select a language preference. For example, modules of the decision-assistance system 10 may be implemented in U.S. English, Mexican/South American Spanish, or some other language. Optionally, the decision-assistance system 10 may include modules that enable multilanguage capability.

In some cases the account processing module 42 includes capabilities that permit certain information to be designated as confidential. In such cases, some or all of the information entered by a decision maker may be encoded, encrypted, or securely stored in another way. The information may be restricted from nonconfidential decision streams. The information may be directed only to advisers expressly selected by the decision maker and not to adviser groups or other uncontrolled, unselected parties. In some cases, there may be multiple levels of confidentiality. For example, a first level of confidentiality may permit sanitized information (i.e., information in which personally identifiable attributes of the information are removed) to be used in a decision stream provided to others. A second level of confidentiality may prohibit access to the information by any unauthorized parties.

The demographic module cooperates with the name/identification portion of the account processing module 42. Demographic information associated with any particular user of the decision-assistance system 10 may be stored and retrieved as necessary. The demographic information may be used to suggest particular groups or communities of advisers to a decision maker. The demographic information may be used to classify an adviser into one or more expert groups or communities. In the decision-assistance system 10, the demographic information for any particular user may include one or more of age, geographic location, gender, profession, current or past employment history, educational level, courses of academic study, and the like.

The account processing module 42 includes logic for managing credit and points in the decision-assistance system 10. A credit/points module may optionally be defined to perform credit-management tasks. Credits may be thought of as a form of currency within the decision-assistance system. Credits may be purchased with a form of digital payment such as a credit card, an electronic funds transfer, by using secret information authorized by a financial institution, with digital currency such as BITCOIN, or with some other form of consideration. In addition to purchasing credits, credits may also be earned with points obtained in recognition of having given good advice.

Within the decision-assistance system 10, points may be earned by advisers who provide advice to a decision maker. In some cases, a decision maker or another entity may rate the quality of the provided advice, and advice that is deemed to have higher quality receives more points than advice that is deemed to have lower quality. Stated differently, more points may be earned by an adviser for advice that a decision maker finds useful. Refer herein to Table 1.

In some embodiments, credits that are purchased have an equivalent value to credits that are earned. In other embodiments, purchased credits and earned credits are valued differently. In one embodiment, for example, credits that are purchased may hold twice the value as credits that are earned. The price of credits may change as demand for services of the decision-assistance system 10 changes. In addition, or in the alternative, the value of credits earned may change as demand for services of the decision-assistance system 10 changes.

Credits are assigned to a particular registered user of the decision-assistance system 10, and the credits are administered within the account processing module 42. Credits may be transferred between the accounts of registered users based on appropriate authorization.

Credits may be used to subscribe to decision themes, communities, decision tools, and information associated with decisions to be made.

Personal network logic affiliated with the account processing module 42 is used to administer a personal network associated with each registered user of the decision-assistance system 10. A personal network may have no members, one member, or a plurality of members. Members of a personal network are other registered users of the decision-assistance system 10.

Each registered user of the decision-assistance system 10 may create and manage his-or-her own personal network. The personal network of a registered user may include any other registered user of the decision-assistance system 10. In many cases, a personal network includes family, friends, neighbors, and others with whom the registered user is affiliated, knows, or is otherwise connected to. The registered user owner of a personal network can invite other registered users to join his or her personal network, and the invitation can be accepted, declined, or ignored. The registered owner user can invite members of his-or-her personal network to be a decision adviser. The invited user can accept, decline, or ignore the invitation to be a decision adviser.

A registered user can create, modify, and delete any number of adviser groups. Members of the registered user's personal network can be added to one or more adviser groups. An adviser group often includes a plurality of users. Different adviser groups of a registered user may include, for example, a group of neighbors, a group of colleagues, a group of family members, and the like. An adviser group may be formed using demographic information. Decision advice can be requested from individual users or from an entire user group.

Any registered user of the decision-assistance system 10 can invite people who do not currently have an account to become a registered user. In some embodiments, the invitation to become a registered user includes an invitation to become part of the sender's personal network.

In some embodiments of the decision-assistance system 10, a community is a group of registered users united by affiliation. Examples of affiliation might include employees in a company, students at a university, members of a club, voters in a city, or any other type of grouping. The decision-assistance system 10 may be provided with a default set of communities defined by particular parameters, and additional communities may be created by administrators and users of the decision-assistance system 10. Management of communities is administered by communities logic associated with the account processing module 42. Accordingly, a user of the decision-assistance system 10 may direct the administration of one or more communities via the communities logic.

In some cases, the communities logic or module maintains a dynamic database of community names and properties. In some cases, the communities logic or module automatically recognizes when a particular group of advisers is selected by a decision maker and in this case, a new community is automatically created. The new community may be given a name formed by the decision-assistance system (e.g., by the natural-language-detection module 34). In addition, or in the alternative, the new community may be named by a decision maker associated with the community.

Communities may be of particular interest to small, medium, or large organizations. For example, a university may want to provide decision advice to students selecting courses and/or majors. In such a case, the university may create one or more communities based on class status (e.g., freshman, sophomore, . . . ), school (e.g., school of engineering, school of fine arts, . . . ), major course of study (e.g., medicine, mathematics, political science, . . . ), and the like. When students or prospective students access the decision-assistance system, the students may present a decision to be made to a particular community, and the student will receive advice from members of the community. For example, an engineering student may seek advice on a decision to be made regarding a particular class schedule or a particular professor.

Any registered user of the decision-assistance system 10 can initiate a community. The same or another registered user can administer the community. The administrator can help prospective users of the decision-assistance system 10 become registered users and community members. The community administrator may also be privileged to add, remove, and otherwise modify certain account information of community member accounts. In some cases, a membership roster of a community is only visible to members of the community. A user can belong to none, one, or several communities.

In one embodiment of the decision-assistance system 10, any registered user is permitted to create a community. The user may represent a business entity and/or some other organization such as a club or a school. In the embodiment, the community may be created as a private community. In this case, users of the decision-assistance system 10 may only participate in a community if they are invited by the community's administrator. Participation in such a community may be visible only to the other participants in the community. Optionally, a user, and administrator, or another entity may control whether or not the participation in a community is viewable to other participants in the community. That is, in some optional cases, a community may have “hidden” participants, and in other cases, all participants are visible to all other participants of a community. Communities may be created for such purposes as guidance, to make expertise easily available, neighborhood socialization, business reference, and others.

In some embodiments, small communities (e.g., fewer than 10 members) may be created without cost. In such embodiments, the formation of a larger community (e.g., more than 10 members) may require the payment of some consideration, for example a particular number of credits.

In some embodiments of the decision-assistance system 10, nonregistered guests are granted access to some functions. A guest module portion of the account processing module 42 administers the activities of nonregistered guests. A nonregistered guest may, in some cases, be permitted to receive crowd advice from particular communities. For example, when the decision-assistance system 10 is integrated or otherwise affiliated with a social network (e.g., FACEBOOK, TWITTER, LINKEDIN, GOOGLE+, and the like), a nonregistered user of the social network may request advice on a decision to be made. The decision to be made may be presented to a community of registered users, and the registered users may provide advice associated with the specific options being considered for the decision. In some cases the registered users may also provide comments or other advice. The decision maker can then receive the accumulating crowd advice and, in some cases, the additional comments.

Access to the decision-assistance system 10 functions from other social networks may encourage nonregistered guests to become registered users.

A business module portion of the account processing module 42 administers accounts associated with particular entities such as businesses. In this way, an organization may be a registered user of the decision-assistance system 10. The organization may be a for-profit business, a nonprofit business, a government entity, an educational institution, or any other type of entity. In some cases, a business is a surrogate for an individual person, and in other cases a business is a surrogate for a group of people.

When a registered user is designated as a business, the registered user may have an extended profile. The extended profile may be populated with information managed by other logic of the account processing module 42. For example, a business may have one or more names which can be managed by the name/identification logic. The business may have multiple locations, products, services, and the like that are managed by the demographic logic. A business may accumulate credits (e.g., through the conversion of points into credits) via payment or when its members collectively provide advice, and the credits/points are administered by the credit/points logic.

In many ways, the extended profile of a business is similar to a personal profile associated with an individual registered user of the decision-assistance system 10. The extended profile may include additional telephone numbers, days and/or hours of operation, business addresses, logos, product and/or service names, pictures, email addresses, website links, and other information. In some cases, the owner of a business profile may enter any desirable information, which can then be accessed by other users of the decision-assistance system 10.

In some cases, businesses seek help making decisions. A representative of a business may seek advice on a decision to be made regarding product research, access to credit, expansion into new territories, or any other type of decision. The business may specifically direct its request for assistance to advisers having particular demographic properties. Stated differently, advice may be sought from particular communities defined in the decision-assistance system 10

The decision-assistance server 14 includes a theme-recognition logic module 36. The theme-recognition module 36 determines themes present amongst input information from a user of the decision-assistance server 14. The theme-recognition module 36 cooperates with the natural-language-detection module 34 by analyzing particular words and word combinations. In some embodiments, the theme-recognition module 36 analyzes the “possible” subject matter, “possible” actions, and “possible” choices (FIG. 4). In other embodiments, the theme-recognition module 36 analyzes the proposed subject matter, the proposed action, and the proposed choices, which have been produced by the natural-language-detection module 34. In still other embodiments, the theme-recognition module 36 receives selected subject matter, selected action, and a choice that has been selected by the decision maker and output from the natural-language-detection module 34 as a form decision question.

A theme may include any information that is desirable or potentially desirable to a registered user of the decision-assistance system 10. In many cases, registered business users are more interested in themes than nonbusiness registered users. In this respect, access to particular decision streams may be provided to registered business users in return for consideration such as credits.

A theme, as used in the decision-assistance system 10, includes a subject and zero or more qualifiers. To further clarify a “theme,” a first nonlimiting example is presented with respect to FIGS. 3 and 4. In the first nonlimiting example, the theme is “tattoo,” and the zero or more qualifiers include “purchase,” “persons aged 18-25 years old,” and a “geographic area within 20 miles” of a particular tattoo provider.

In this first example, a particular business is a tattoo provider. The tattoo provider becomes a registered business user of the decision-assistance system 10. The tattoo provider pays a determined fee to the owner or administrator of the decision-assistance system 10. In return for the fee payment, the tattoo provider requests access to certain information associated with body art themes and tattoo themes. The tattoo provider may also refine its request to access body-art and tattoo themes with certain qualifiers such as decisions associated with purchasing a tattoo or body art, decisions associated with people of a certain demographic (e.g., people aged 18- to 25-years old), decisions associated with people from a certain geographic location, and other qualifiers. Based on the selected themes and qualifiers to the themes, the tattoo provider will receive access to information when 18 to 25 year old decision makers located within 20 miles of the tattoo provider request advice on decisions related to purchasing a tattoo or body art.

In one case, when an 18- to 25-year-old decision maker located within the 20 mile radius of the tattoo provider enters a decision to be made as illustrated in the tattoo embodiment of FIG. 3, the tattoo provider will receive information associated with the decision processing. In addition, for every other decision maker who meets the age and geographic qualifications and requests advice on a tattoo purchase decision to be made, the tattoo provider also receives information associated with the decision processing of those decisions to be made. The cumulative set of qualified decisions to be made is referred herein as a decision stream.

In the first example, if 50 people aged between 18 and 25 years old and located within 20 miles of the tattoo provider seek help from advisers regarding the purchase of a tattoo, the tattoo provider will receive access to the information. The information associated with each of the 50 decision makers is collectively referred to as a decision stream. The information that the tattoo provider has access to may include identification information associated with the individual decision makers. In addition, or in the alternative, the information that the tattoo provider has access to may include one or more advertisements of the tattoo provider communicated to a computing device of each of the 50 decision makers, and in this case, the tattoo provider will not receive any personally identifiable information associated with any of the decision makers unless disclosure of such information is explicitly authorized by each decision maker.

A theme is a collection of information associated with a plurality of decisions to be made. The theme-recognition module 36 identifies themes. At any point in time, the decision-assistance system 10 may be processing hundreds, thousands, and millions of decisions to be made. As each decision to be made is formulated in a question having a subject, an action, and at least two decision choices, the theme-recognition module 36 identifies one or more individual themes.

A theme-processing module 38 processes additional information associated with the recognized themes. The theme-processing module 38 cooperates with the theme-recognition module 36 and a theme-distribution module 40.

A theme directs timely alerts to decisions being made that are related to the subject matter and demographics of interest to a user. For example, the theme, “Purchase Refrigerator,” alerts theme subscribers to decisions being made about the purchase of a refrigerator. Decision alerts can be qualified or otherwise filtered by certain demographics such as geography, age, gender, and others. A user in the business of selling refrigerators—or home appliances—could convert such an alert into a sales lead. Themes can refer to any of a large number of decision arenas. The theme-recognition module 36 automatically recognizes one or more themes to which a decision belongs. The decision-theme processing module 38 aligns the recognized themes with registered users who subscribe to decision streams related to such themes.

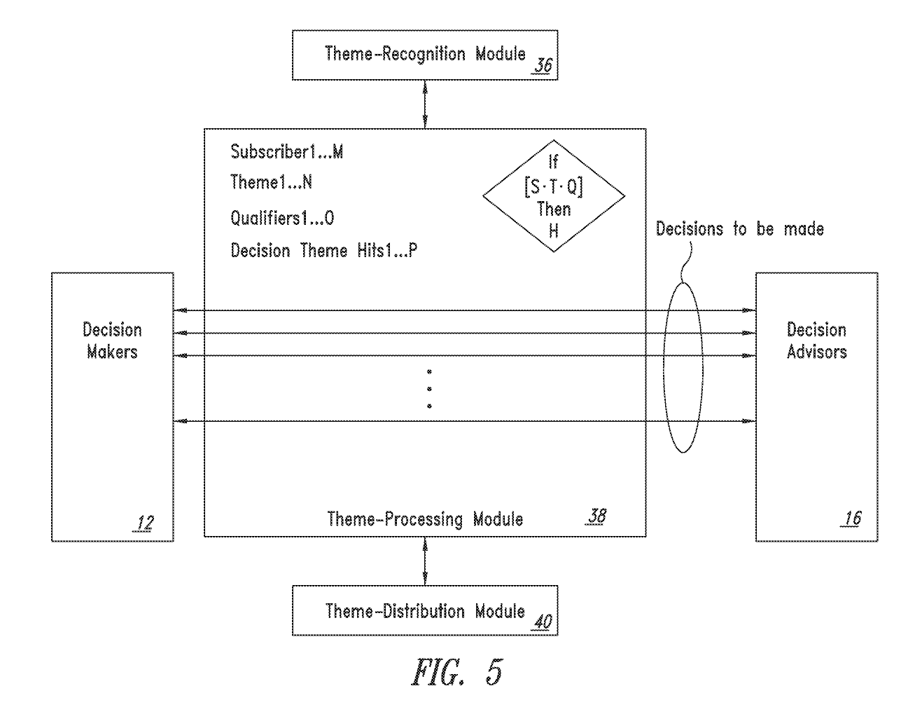

FIG. 5 is an embodiment of a theme-processing algorithm. During operation of the decision-assistance system 10 a plurality of decisions to be made pass between decision makers 12 and decision advisers 16. The number of decisions to be made may be tens, hundreds, thousands, or millions. The theme-processing module 38 cooperates with the theme-recognition module 36. The theme-processing module 38 coordinates any number of registered subscribers 1 . . . M, with any number of themes 1 . . . N of interest to the registered subscribers and filtered by any number of qualifiers 1 . . . O, wherein “M,” “N,” and “O” each represent an integer.

The theme-processing module 38 monitors all of the decisions to be made, and when a properly qualified theme of a particular subscriber is detected, the theme-processing module 38 recognizes a decision theme hit. The collective set of decision theme hits 1 . . . P are illustrated in FIG. 5, wherein “P” is an integer.

The theme-processing algorithm is further illustrated in FIG. 5 as a decision box (i.e., diamond) in which, for each subscriber “S,” one or more themes “T” are qualified, “Q,” and combined with each of the decisions to be made via combinatorial logic. If a properly qualified theme is detected, a decision theme hit “H” is asserted. Decision-theme hits, which may also be called alerts, are communicated with a cooperative theme-distribution module 40.

The theme-distribution module 40 communicates information associated with recognized and processed themes to registered users that have subscribed to receive such themes. The theme-distribution module 40 may include logic to coordinate themes with individual registered users that subscribe to the themes. The theme-distribution module 40 may combine a plurality of themes to create a composite theme. The theme-distribution module 40 may allow registered users to provide names or other identifiable characteristics to themes that they are subscribed to. One example could be, “Purchase Life Insurance.” By subscribing to a theme, a business user can be promptly notified by the theme-distribution module 40 of decisions in progress within that set of decision classes. Decision-theme hits (i.e., alerts or notices) are triggered in the theme-processing module 38 when a theme is detected and properly filtered by geography, demographics, and/or other characteristics per the interest of the subscribing registered (business) user. The registered business user can convert some of the resulting notices into business leads or other opportunities such as directing particular advertising to registered users who participated in a detected theme and qualified. For example, a geographically filtered theme named “Purchase Life Insurance” might be valuable to life-insurance agents serving a particular city and surrounding area. In some embodiments, for a price (e.g., in credits), a theme can be made available for a specified length of time.

The decision-processing module 44 cooperates with other modules to coordinate and move information through the decision-making-assistance server 14 and to perform particular processing on the information that passes through the module. Additional modules, which may include submodules and portions of modules, are included within the functionality of the decision-processing module 44. For example, the decision-processing module 42 may optionally include a decision-maker-input module, an adviser-output module, an adviser-input module, a decision-maker-output module, a timing-logic module, a decision-logic module, and a semaphores (colors) module.

A decision-maker input module of the decision-processing module 44 accesses information prepared by the natural-language-detection module 34 such as properly formed questions representing decisions to be made. The properly formed questions representing decisions to be made have already been approved by the decision maker. In these cases, the decision-maker-input module and the adviser-output-module will cooperate with the account-processing module 42 to communicate a question that represents a decision to be made to one or more decision advisers.

An adviser-input module of the decision-processing module 44 will accept and process advice received back from the one or more decision advisers. The advice that is received is in response to the request for advice sent by a decision maker along with the decision to be made. In some cases, the advice is simply an opinion of each of the choices mentioned for the decision to be made. In other cases, additional advice is provided (e.g., suggested choices, comments, pictures, audio, network links, and the like). A decision-maker-output module processes and communicates the received advice back to the decision maker. In some cases, the raw advice received from the decision advisers, including any comments or other input, is passed back to a decision maker. In other cases, the raw advice from multiple decision advisers is accumulated, consolidated, or otherwise processed before being passed back to the decision maker.

In a first mode of operation, a registered user of the decision-assistance system can request advice from one or more specific individuals. Decisions sent for the advice of specific individuals are passed through the decision-maker-input module and the adviser-output module, and the decisions include a decision-to-be-made question and a plurality of choices. The decision may also include a more detailed decision description and context (i.e., hopes and/or concerns).

Upon receipt of the decision to be made, each individual adviser can offer advice. The advice is passed through the adviser-input module, and the advice may simply indicate which choices the adviser prefers or the advice may indicate how much the adviser likes each of the choices being considered. In cases in which the adviser indicates a degree of preference, the adviser may use colors (i.e., semaphores) to represent the degree of preference. In addition, in some embodiments, the individual adviser can provide opinion information about each choice, suggest other choices, and include other advice. The decision-processing module 44, in cooperation with the account-processing module 42, indicates to the decision maker which particular adviser provided the advice.

After the advice is provided to the decision maker via the decision-maker-output module, the advice may be graded by the decision maker. In this case, the decision-maker-input module receives the grade information. For example, after receiving advice, the decision maker may grade each piece of advice as “Not Useful,” “Useful,” “Very Useful,” “Brilliant,” or with some other indication. Each grade can result in points (which, in sufficient quantity, can be converted into credits) granted to the individual adviser. The adviser can use credits to purchase such items as theme subscription or access to a suite of decision tools.

In a second mode of operation, a decision maker can receive advice from a larger group such as a community or a crowd. Different from the first mode of operation in which the decision maker requests advice from specific individuals in the decision maker's network, in the second mode, the decision maker may or may not know all of the individuals who are being asked for advice. The group that is asked for advice may be small (e.g., <10), or the group may be large (e.g., >100). In some cases, the group is huge (e.g., >1M). The group may be a community of individuals in the decision maker's network. In addition, or in the alternative, the group may be small (e.g., 2-10) or large (e.g., 100-1,000) group of users of the decision-assistance system who are not yet part of the decision maker's network but are otherwise associated by some common affiliation.

In this second mode of operation, each adviser reviews the decision to be made, and each adviser may then be permitted to cast at least one semaphore opinion of each choice being considered. A semaphore may be represented as a color, such as green, yellow, and red, wherein each color represents a degree of preference for one of the choices provided in the decision to be made. In one nonlimiting example, a decision maker provides to a crowd a decision to be made having three choices. Each adviser may provide a green semaphore for each choice the adviser likes, a yellow semaphore for each choice with respect to which the adviser is neutral, and a red semaphore for each choice the adviser dislikes. Input is received back from the crowd via the adviser-input module, and the input is processed by the decision-processing module 44. In cases where advisers provide semaphores to indicate their “like,” “neutral,” or “dislike” of each option, the semaphores module operates to collect, aggregate, store, distribute, and/or otherwise process the semaphore information. Via the decision-maker-output module, the decision maker receives aggregate results, which may include numbers of each semaphore selected by the crowd, percentages, or some other measure. In some embodiments, members of the community or crowd are permitted to include a brief note to the decision maker. In such cases, if the author of the note (i.e., the adviser) is identified, the adviser can be graded, resulting in points (which, in sufficient quantity, can be converted into credits) awarded to the adviser.

Considering the first and second modes of operation as processed by the decision-processing module, advisers may provide different levels of advice, and the advice may be communicated back to the decision maker in various ways. Three scenarios are discussed immediately below.

In a first scenario, for example, when a decision to be made is provided in the first mode to one or more specific individuals, the advice that is received may include a selection of a particular choice, a semaphore color for each choice, additional advice regarding the decision to be made as a whole or regarding any one or more choices, comments, alternative suggestions, and the like. In these cases, the decision maker will often receive all of the provided advice along with attribution to the specific adviser that provided the advice.

In a second scenario, when a decision to be made is provided in the second mode of operation to a community, the advice that is received may also include a semaphore color or a selection of a particular choice. The advice may also include additional advice such as comments or alternative suggestions. In these cases, however, the decision maker may or may not receive all of the “extra” advice, and the decision maker may or may not learn who provided the specific advice. For example, in some communities, such as a community of residents in an entire city, the decision maker may not learn who provided specific advice. In other communities, however, such as a community of residents in a particular neighborhood or apartment building, the decision maker may learn who provided specific advice.

And in a third scenario, when a decision to be made is provided in the second mode of operation to a crowd, the advice that is received will generally only include advice directed to a semaphore color, such as a percentage of advisers in the crowd that selected a particular semaphore color for each choice. In these cases, even if additional advice, comments, alternative suggestions, or the like is provided by an adviser, the decision maker will generally not receive any information identifying a specific adviser.

In some embodiments, a decision maker can post several concurrent decisions to be made. For example, in one embodiment, up to 5 decisions to be made can be concurrently considered “active.” In other embodiments, another number of decisions may be concurrently active. In some cases, a decision maker may have record information associated with a number of decisions to be made. In such cases, the decision maker can direct some of the decisions to be made into an active status and others of the decisions to be made into an inactive status. Old (i.e., previous) decisions may also be archived for future reference.

An active, pending decision may receive advice during a particular time window. The time window functionality is administered by a timing-logic module of the decision processing module 44. The time window may open when a decision to be made is passed to one or more advisers through the adviser-output module. Alternatively, the time window may open at a different time such as a time selected by the decision maker. The timing-logic module may fixedly or changeably determine when the time window closes, which indicates that advice for a particular decision to be made will no longer be accepted. When a time window will close, or when a time window duration is changeable, it may be the decision maker or another party that selects the time parameters associated with opening and closing the window.

Using decision-logic functions of the decision-processing module 44, a decision maker can also perform certain acts on records of decisions to be made. For example, decisions to be made can be archived, duplicated, deleted, edited, and the like. In some cases, records of decisions to be made may be protected as confidential or they may be freely shared amongst other users. The records may be electronically transferred in whole or in part, and the records may be stored in a database and mined for information, which may then be distributed in return for consideration.

In addition to capturing and properly routing information between decision makers and decision advisers, the decision-processing module 44 may also include a decision-logic module formed as one or more submodules or functions. The decision-logic module of the decision-processing module 44 may include one or more tools to facilitate decision formation, decision analysis, decision-trap avoidance, report generation, and the like. A nonlimiting list of exemplary decision tools includes force fields, decision hierarchies, decision tables, an issue-podium, relevance diagrams, and a decision quality (DQ) measurement. In some embodiments, access to such decision tools may be in return for consideration such as credits.

One decision tool administered or otherwise provided by the decision logic includes a “pretty darn quick” (PDQ) tool. PDQ decision advice allows the decision maker to receive aggregate advice from a large number of advisers such as a crowd. The crowd may include known advisers, but in many cases, the advisers include a potentially large number of unidentified individuals. In a PDQ decision, the tool permits each adviser to vote with a semaphore where, for example, green=like, yellow=neutral, and red=dislike. Advice from the crowd is reported by the PDQ tool in terms of number of votes per semaphore color or a percentage or using some other measure.

The PDQ tool may be simple and straightforward in principle, but the tool as embodied herein can only be administered within a decision-assistance system 10 because such system can connect a decision maker to a large plurality (e.g., tens, hundreds, thousands, or millions) of decision advisers in real-time. In one nonlimiting example, the PDQ tool is used during a nationally broadcast sporting event. In this case, a team representative may instantly ask team fans for assistance making a decision such as, “Should the team replace Jon Carswell with Tino Rodriguez, Ji-Ling Soo, or Stephan Wolf?” or “Should the team execute a running play, a passing play, or a Hail Mary play?” The crowd, or fans, may be chosen from registered users having particular information stored in an account profile. During the sporting event, the decision to be made can be carried out in real time. The decision results may also have sufficient confidentiality so as to be kept private from an opponent. It is recognized that the PDQ tool may be used in other situations as well by manufacturers of products, providers of services, or others.

Another tool that may be provided by the decision logic is an issue podium tool. In this tool, a decision to be made that has many interested parties (i.e., stakeholders) can be made in response to issues voiced by several individuals who, in aggregate, represent the stakeholders. An issue podium is a tool that facilitates raising, consolidating, ranking, and distilling issues from a diverse group of individuals. The issue podium tool can permit representatives of a union, for example, to gather member advice regarding contract provisions. Elected officials can gather advice from constituents using the issue podium tool as well, and so can other groups. In some embodiments, the issue podium tool permits additional input information to be consolidated into a sequence of requests for advice.

In a force-field tool, two or three (or more) options are compared in terms of their respective advantages and disadvantages. In a force field, each advantage and each disadvantage is depicted weighed by its subjective strength relative to other advantages and disadvantages.

The decision logic in some cases includes a decision-trap glossary tool that can be used to identify and avoid or mitigate decision traps. In some embodiments, the decision-trap glossary tool is automatic and operative in real time to guide a decision maker who is forming a decision to be made. The decision-trap glossary may include a structured glossary of names and brief descriptions of common or insidious decision traps. The decision trap glossary tool may cooperate with the natural-language-detection module 34 and provide suggestions to avoid or mitigate the effects of detected words or word phrases. Particular traps can be grouped in categories such as “individual,” “large organization,” “medical,” “government,” “perverse (which snare decision makers in just about every context),” and many others. Exemplary trap names may include, “Going to Abilene,” “Jack Attack,” “Group Think,” “Sledge Hammer,” “Buridan's Burro,” and the like. The database of traps and suggestions is dynamic and may grow large.

A decision-hierarchy tool helps determine the scope of a decision to be made. A decision-hierarchy tool may, for example, help identify previous decisions that enable or constrain decision(s) to be made, and a decision hierarchy tool may, for example, help identify associated decisions that can be made separately (e.g., deferred) from the decision(s) to be made. During operation of the decision-assistance system 10, a decision maker may form and execute a sequence of related decisions to be made. For example, a decision maker may first request help deciding if a refrigerator should be repaired or replaced and, if so, respectively, by what service provider and by what brand and model. The decision maker may then ask for help deciding which service provider to choose or what brand of refrigerator to purchase. Subsequently, the decision maker may ask for help with additional decisions such as where to purchase a new refrigerator, whether to buy an extended warranty, whether to seek store delivery or third-party delivery, and the like. In these cases, related decisions may be classified and “sandwiched” between other decisions. In some cases, some previously made decisions are taken as given and not challenged; other peripheral decisions may also be made separate and distinct from a central focus decision to be made. Turning back to the refrigerator example, the central focus decision may be related to the specific purchase, and peripheral decisions such as related to French-doors, top-bottom, cubic feet, height, width, required power, color scheme, and the like may all be formed as decisions to be made, and all of these periphery decisions to be made may be placed in a hierarchy. Stored hierarchies can be used to assist future decision makers as suggestions in a progression or sequence of decisions having the same or similar subject matter.

A decision-table tool may also be provided by the decision logic of the decision-processing module 44. The decision table is used to help a decision maker formulate options for a decision. For example, it has been recognized that a “good” decision within the decision-assistance system 10 is made amongst two to a handful (e.g., five) of options that are: 1) mutually exclusive; 2) substantially different from one another; 3) attractive and acceptable to the decision maker; 4) feasible by the decision maker; and 5) ballistically defined, which means having sufficient but not excessive detail for the people and/or organizations responsible for executing the actions implied by the selected choice with little or no additional guidance from the decision maker. The decision-table tool may cooperate with the natural-language-detection module 34, and the decision-table tool may draw information from an indexed database of past decisions.

In some embodiments, the decision logic may include a qualitative decision diagramming tool. A decision diagram drawn by the tool may comprise one or more bubble-and-arrow images that depict in a single page a decision to be made and two or more alternative choices. The diagram may also include uncertainties, valuation (i.e., preferences and trade-offs), and other notes or information requested or provided by the decision maker. In some cases, the decision-diagramming tool may be accompanied by six-spoke radar plots (e.g., with six spokes or some other number) or antenna plots, also known as flagpole plots (e.g., with 7 to 20+ antenna “poles” or with some other number). As an example, a six-spoke radar plot may depict six required decision-quality (DQ) dimensions: 1) Frame, 2) Alternatives, 3) Valuation, 4) Predictions, 5) Reasoning, and 6) Commitment. In addition to a required number of dimensions, a flagpole diagram can include: 1) Information, 2) Fitness, 3) Ethics, 4) Timing, 5) Risk, 6) Refinement, 7) Challenge, and others.

Embodiments of the decision-assistance system 10 maintain an indexed database of decisions. The indexed database may be maintained by the decision logic of the decision-processing module 44 or by another module. Reports having any format and including any information may be generated. In some cases, standardized reports are made available. In addition, or in the alternative, customized database queries and reports may also be generated. Exemplary information in the reports may include the frequency with which decision makers request assistance in a particular subject matter, reports directed to current topics in popular culture, reports directed to political topics, and the like. Such reports can be segmented by geography, age, gender, or any other demographic information. Certain reports may be freely available, and other reports may be available in return for consideration such as credits.

Within the indexed-database functionality, information associated with decisions to be made may be automatically or manually indexed and stored. Decisions may be indexed by class, which is characterized by an action (e.g., purchase) and a subject (e.g., refrigerator). The automatic decision-indexing may draw information from the natural-language-detection module 34. The decision-indexing and -classification methods may apply Bayesian learning and semantic-network techniques or other techniques.

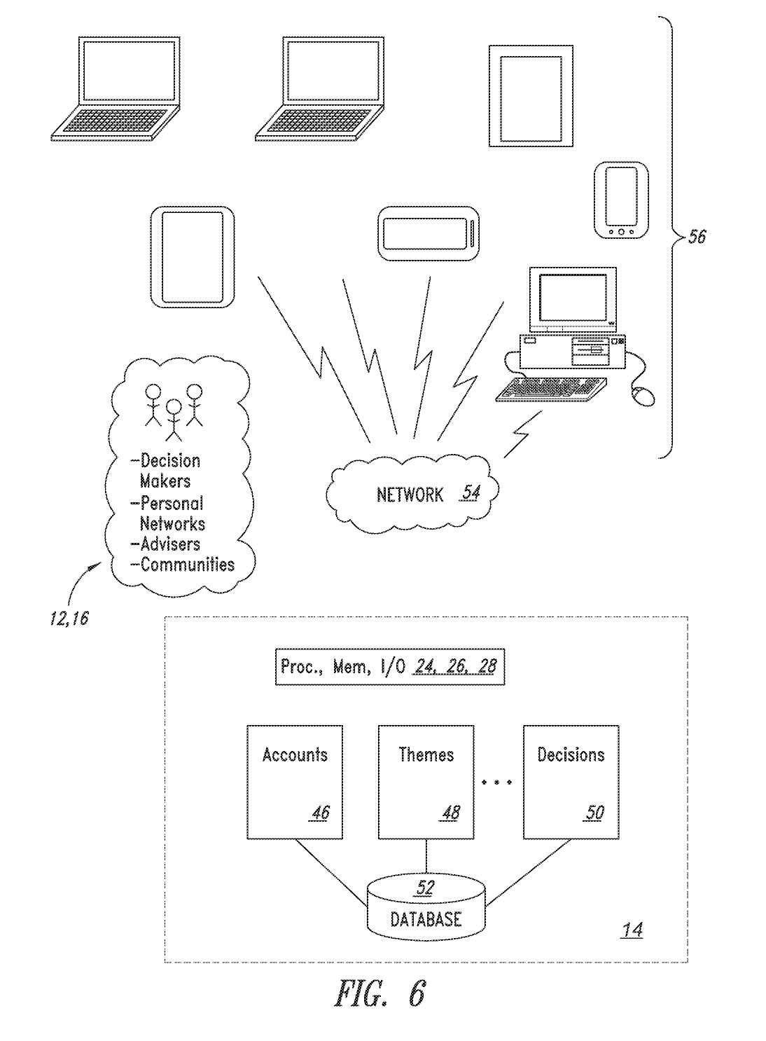

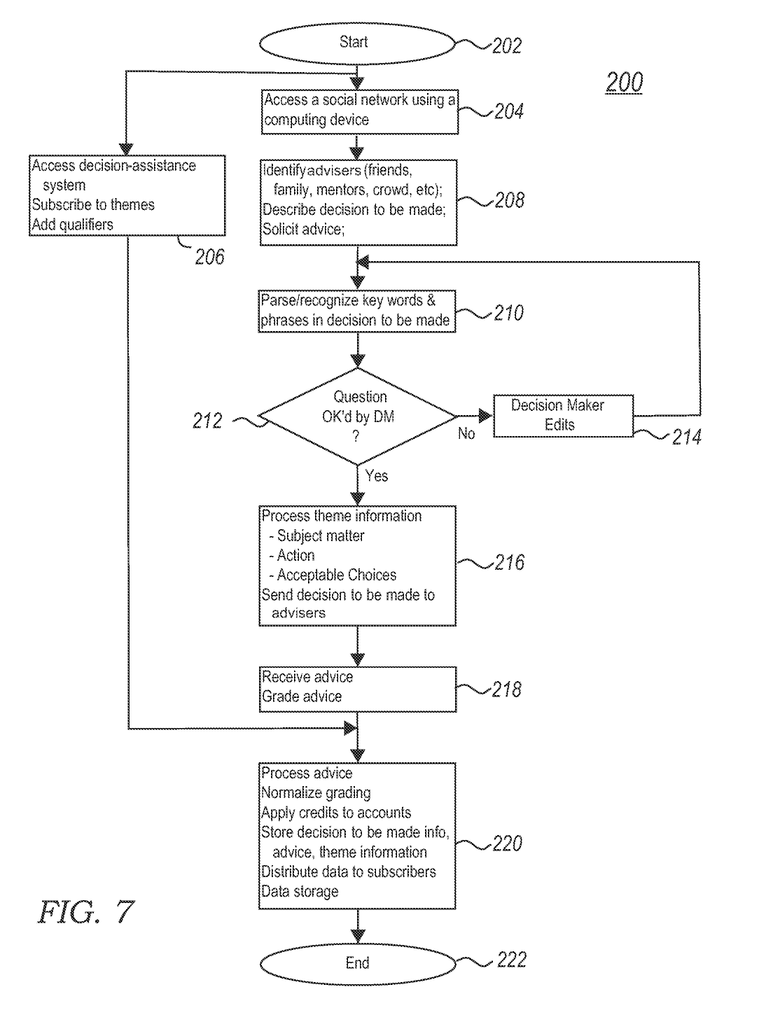

FIGS. 6 and 7 are now described in relation to each other. FIG. 6 is another embodiment of a decision-assistance system, and FIG. 7 is a processing embodiment in a decision-assistance system 200.

FIG. 6 illustrates components described herein, and components with common reference numbers indicate logic, modules, and otherwise as described herein. A decision-making-assistance server 14 includes a processing-logic module 24, a memory interface module 26, and an input/output interface module 28. The decision-making-assistance server 14 also includes an account processing module 46, a themes-operations module 48, a decision-processing module 50, and other processing modules. A data repository (e.g., a database) 52, is also accessible to the decision-making-assistance server 14. A plurality of individuals and other entities such as businesses 12, 16 form one or more groups of decision makers, personal networks, advisers, communities, a crowd, and the like. The plurality 12, 16 interact with the decision-making-assistance server 14 via computing devices 56 communicating through a wide-area network 54 such as the Internet.

In the processing embodiment 200 of FIG. 7, processing begins at 202.

At 204, a decision maker operates a personal computing device 56. In this respect, a plurality of decision makers may all be operating their own associated computing devices. Concurrently, there may be more than 100,000 decision makers all accessing the decision-making-assistance server 14 via a social network operating throughout the Internet (i.e., network 54). Accessing the social network via the computing device generally includes passing personal information through an interactive interface to a computing server communicatively coupled to the personal computing device; however other methods are also considered. In one embodiment, the decision maker receives displayable webpage information from the computing server, which forms at least a portion of the interactive interface. In other embodiments, the information may be communicated through electronic mail, short message service (SMS) text messages, video, audio, or by other mechanisms,

Turning to processing at 206, before, after, or while decision makers are accessing a social network at 204, other individuals or entities, such as business users, are accessing the decision-making-assistance server 14. These other individuals or entities may pass system-wide unique account information through an interactive interface to a computing server communicatively coupled to the personal computing device similar to individual users or they may access the decision-making-assistance server 14 in other ways. The other individuals or entities are interested in decision themes and they subscribe to one or more decision streams associated with particular themes of interest. Subscribing to a theme may include exchanging money or some other object of value in consideration for the privilege of subscribing. In some cases, the selected themes may be based on particular keywords typed in by the individual or entity; in other cases, the individual or entity may select from themes that are already recognized and provided by the decision-making-assistance server 14. The subscription to a decision stream may be qualified by geography, demographics, time, and in other ways. Within the decision-making assistance server 14, the accounts-processing module 46 and the theme-operations module 48 cooperate to manage a plurality of subscriptions that each identify at least one theme. In this respect, the theme-operations module 48 determines when a theme is identified in an active decision to be made, and the theme-operations module 48 can direct communication of at least some of the decision information to an account of the subscriber associated with that particular theme.

At 208, the decision maker identifies one or more advisers. The advisers may be friends, family members, neighbors, mentors, or other expressly identified people. Alternatively, the decision maker may simply request information from a “crowd.” The crowd may be a wide audience selected by the decision-making-assistance server 14, or the crowd may be a group of individuals associated by a common trait or other characteristic (e.g., age range, geographic location, employer, etc.). The decision maker additionally identifies a decision to be made and solicits advice from the advisers by requesting decision assistance regarding the decision to be made. When describing the decision to be made, in some cases, the decision maker may type or speak information into a personal computing device; in other cases, the decision maker may simply select a preformed question generated or otherwise provided by the decision-making assistance server 14.

At 210, the decision-making assistance server 14 will parse or otherwise recognized human language keywords, word objects, and phrases in the decision to be made. In some cases the parsing and recognition includes analysis of stems (i.e., roots) of words, synonyms, antonyms, and related words as defined in one or more dictionaries. In these cases, or in other cases, recognized words are weighed by a frequency indicating how often a decision within the decision theme is to include a particular word. From the input provided by the decision maker, one or more subjects of the decision to be made can be recognized as well as one or more actions associated with the decision to be made. Choices considered for the decision are also parsed or otherwise recognized. The decision-making-assistance server 14 then generates or otherwise provides a decision-to-be-made question.

Interactively, at 212, 214, and 210, the decision maker is permitted to review the decision to be made as it will be delivered to the group of advisers. The decision maker can edit, amend, rephrase, or otherwise access the decision-making-assistance server 14 to form a decision-to-be-made question that is acceptable.

At 216, the decision-making-assistance server 14 continues processing theme information. For example, subject matter is identified, action is identified, and a set of choices for the decision to be made that are considered by the decision maker are identified. In some cases, the decision-making-assistance server 14 includes a natural-language-processing module to automatically detect theme information from the input provided by decision makers and advisers; in other cases the theme information may be selected by a decision maker from choices provided by the decision-making-assistance server 14. The particular decision theme information may correspond to an entry in a classification database of categories of decisions to be made. New decision-theme categories may be created dynamically; seldom-used decision themes may be retired too long-term storage or deleted if they are considered anomalous or otherwise not useful. The decision-making-assistance server 14 communicates the decision to be made to the selected advisers along with a plurality of choices for the group of advisers to consider.

At 218, over a period of time that may be controlled, the decision-making-assistance server 14 receives advice from zero or more of the advisers. The advice is then provided to the decision maker. The advice may optionally include a percentage of choices that were preferred by the advisers, notes, or other advice provided by the advisers. The decision maker may then be given an opportunity to grade the advice. Various grading systems are considered such as a norm-referenced system, a selected criterion-referenced system, or a selected peer-evaluation referenced system. In some cases the decision maker will assign one grade to each separate instance of advice; in other cases, the decision maker will assign a single grade to all of the advice received from a plurality of advisers. Based on the grade, advisers may receive points (which, if in sufficient number, may be converted into credits) proportional to the quality of their advice.

At 220, the decision-making-assistance server 14 processes the advice. Processing may include normalizing the grades provided by the decision maker, applying earned points to accounts of the advisers, storing information associated with the decision to be made, and distributing associated data to subscribers. In some embodiments, when a theme associated with a decision to be made is recognized as a theme of interest subscribed to by a particular individual or entity, the decision-making-assistance server 14 will provide a timely alert corresponding to the decision theme to the subscriber. Alerts may be sent each time a decision maker solicits advice associated with the decision theme. Alerts may also be sent based on a threshold number of detected themes, a number of themes collected during a particular time frame, or based on other criteria according to qualifications entered when the individual or entity subscribed to the theme. Some or all of the data may be stored in a data repository such as database 52.

At 222, processing ends. It is recognized, however, that the processing illustrated in FIG. 7 may not end, but instead may return to the beginning at 202. Furthermore, the processing illustrated in FIG. 7 may also be duplicated so as to provide service to hundreds of thousands of individuals and entities or more and hundreds of thousands of concurrent active decisions to be made.

Embodiments of the present invention relate to isolating, analyzing, and processing subject matter from electronic messages (e.g., strings of text, audio, still images, video, and the like) to improve the functioning of a computerized social network and thereby the lives of people. For example, the functioning of the computerized social network is improved by efficiently accepting, processing, storing, and delivering decision information. Lives of decision makers, advisers, and people responsible for subscribing to particular decisions being made (i.e., themes) are all improved as described in the present disclosure.

The specification explains the need for computerized social-networking systems to scan and analyze input information associated with a request for help to make a decision. The disclosure describes in detail how decision-related subject matter is identified and physically isolated in one or more particular areas of decision memory so that the information may be efficiently indexed, searched, and otherwise mined for relevant content.

When a communication containing decision-related subject matter is stored in the decision memory, data contained within the communication is compared to known decision-related information that may be stored in a decision database. Various levels of joint analysis or other artificial-intelligence techniques are used to understand the contents of the communication. The presence of particular decision-related subject matter indicates the nature of the decision to be made or decision that has already been made.

The decision-related subject matter may be parsed with text recognition, speech recognition, image recognition, pattern recognition, or other analyses and encoded with one or more levels of granularity such that the decision-related subject matter can be classified and further analyzed. In some nonlimiting embodiments, the parsing module executes a process that scans the communication and identifies a beginning marker of the decision-related subject matter. The process then flags each portion of the decision between the identified beginning marker and an ending marker of the decision-related subject matter. The flagged portions represent constituent parts of decision-related subject matter such as one or more subjects, one or more actions, and two or more choices. The communication is parsed, on a byte-by-byte basis (or some other storage-related quantity), a natural-word-basis, a sentence basis, an idea basis, or some other basis. After parsing, the constituent parts of the decision-related subject matter are further analyzed to determine if the decision subject, action, and choices are recognized as previously known or unknown, Additional processing logic stores the communication and the constituent parts and performs other decision-making features.

The decision-assistance system discussed herein may be configured as a plurality of modules. As used herein, the term “module” refers to an electronic circuit, a processor (e.g., distributed, shared, dedicated, group, single core, multicore, or the like) and memory operative to execute one or more software or firmware programs, an application specific integrated circuit (ASIC), a combinational-logic circuit, or some other individual or cooperative coupling of suitable components (either hardware or software) that provide the functionality described with respect to the module.

As further described herein, a module may include software instructions that are executed by a computing server or a personal computing device. A computing server and a personal computing device includes operative hardware found in conventional computing apparatuses such as one or more central processing units (CPUs), volatile and nonvolatile memory, serial and parallel input/output (I/O) circuitry compliant with various standards and protocols, wired and/or wireless networking circuitry (e.g., a communications transceiver).

As known by one skilled in the art, computing servers and personal computing devices have one or more memories, each memory comprising any combination of volatile and nonvolatile computer-readable media for reading and writing. Volatile computer-readable media include, for example, random access memory (RAM). Nonvolatile computer-readable media include, for example, read-only memory (ROM), magnetic media such as a hard disk, an optical disk drive, a flash memory device, a CD-ROM, and in addition or in the alternative, other data storage devices. In some cases, a particular memory is separated virtually or physically into separate areas, such as a first memory, a second memory, a third memory, etc. In these cases, it is understood that the different divisions of memory may be in different devices or embodied in a single memory.

Computing servers and personal computing devices further include operative software found in conventional computing devices such as an operating system, software drivers to direct operations through the I/O circuitry, networking circuitry, and other peripheral component circuitry. In addition, computing servers and personal computing devices include operative application software such as network software for communicating with other computing devices, database software for building and maintaining databases, and task-management software for distributing the communication and operational workload amongst various CPUs. In some cases, a computing device is a single hardware machine having the hardware and software described herein, and in other cases, a computing device is a networked collection of hardware and software machines working together (e.g., in a server farm) to execute the functions of the decision-assistance system.

In the foregoing description, certain specific details are set forth to provide a thorough understanding of various disclosed embodiments. However, one skilled in the relevant art will recognize that embodiments may be practiced without one or more of these specific details, or with other methods, components, materials, etc. In other instances, well-known structures associated with electronic and computing systems including client and server computing systems, as well as networks have not been shown or described in detail to avoid unnecessarily obscuring descriptions of the embodiments.

Unless the context requires otherwise, throughout the specification and claims that follow, the word “comprise” and variations thereof, such as, “comprises” and “comprising” are to be construed in an open, inclusive sense, e.g., “including, but not limited to.”

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items or ideas and one or more other alternative embodiments that include fewer than all of the associated items or ideas.

The headings and Abstract of the Disclosure provided herein are for convenience only and do not interpret the scope or meaning of the embodiments.

The various embodiments described above can be combined to provide further embodiments. Aspects of the embodiments can be modified, if necessary, to employ concepts of the various patents, application, and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method to receive assistance in making a decision, comprising:
operating a personal computing device by a decision maker;
accessing a social network via the personal computing device, said accessing including passing personal information through an interactive interface to a computing server communicatively coupled to the personal computing device;
receiving displayable web page information from the computing server, the displayable information forming at least a portion of the interactive interface;
passing first input information to the computing server via the interactive interface, the first input information identifying a group of one or more advisers;
passing second input information to the computing server via the interactive interface, the second input information describing a decision to be made by the decision maker;
passing third input information to the computing server via the interactive interface, the third input information soliciting advice from the group of one or more advisers, the advice including decision assistance regarding the decision to be made; and
receiving first output information from the computing server via the interactive interface, the first output information including the advice.

2. The method of claim 1 wherein the interactive interface includes one or more of communications through an Internet web site, communications through electronic mail, and communications associated with a short message service (SMS).

3. The method of claim 1, comprising:
assigning at least one grade to the advice.

4. The method of claim 3 wherein the at least one grade is derived according to a selected norm-referenced system, a selected criterion-referenced system, or a selected peer-evaluation referenced system.

5. The method of claim 1, comprising:
receiving advice from a plurality of advisers; and
assigning a grade to the advice from the plurality of advisers, the assigning including assigning one grade to each separate instance of advice or the assigning including assigning a single grade to all of the advice received from the plurality of advisers.

6. The method of claim 1 wherein the second input information describing the decision to be made includes a plurality of choices for the group of one or more advisers to consider.

7. A method to receive decision-assistance information, comprising:
operating a personal computing device by a representative of a business entity;
accessing a social network via the personal computing device, said accessing including passing system-wide unique account information through an interactive interface to a computing server communicatively coupled to the personal computing device;
receiving displayable web-page information from the computing server, the displayable information forming at least a portion of the interactive interface;
passing first input information to the computing server via the interactive interface, the first input information identifying at least one decision theme, the decision theme including a set of words; and
receiving first output information from the computing server via the interactive interface, the first output information including an alert corresponding to the decision theme, the alert indicating a decision maker has solicited advice regarding a decision to be made and the decision to be made is associated with the decision theme.

8. The method of claim 7 wherein the set of words includes one or more of stems of words, synonyms, antonyms, and related words as defined in a dictionary.

9. The method of claim 8 wherein the set of words is weighed by a probability indicating how likely a decision within the decision theme is to include a particular word.

10. The method of claim 7 wherein the at least one decision theme corresponds to an entry in a classification database of categories of decisions to be made.

11. The method of claim 7 wherein the first output information is a stream of alerts and the representative of the business entity has exchanged one or more credits for access to the stream of alerts, the access associated with at least one of a number of alerts, a geographic region, a group sharing a common demographic parameter, and a time frame.

12. The method of claim 11 wherein the one or more credits are received based on at least one of money paid by the representative of the business entity, a quantity of advice communicated into the computing server and attributed to the business entity, and a quality of advice communicated into the computing server and attributed to the business entity.

13. A decision-assistance server, comprising:
a processor module;
one or more memory storage devices;
a storage interface module coupled to the one or more memory storage devices;
an input/output interface module to pass information to and from the decision-assistance server, the information passed to and from the decision-assistance server including:
first input information from a decision maker identifying a group of one or more advisers,
second input information describing in human language a decision to be made by the decision maker, and
first output advice information provided by the group of one or more advisers;
a natural-language-detection module to detect analyzable word objects within the second input information and to generate decision-to-be-made information;
at least one theme-operations module to determine at least one theme present amongst the second input information; and
a decision-processing module to coordinate communication of the decision-to-be-made information to the group of one or more advisers and to coordinate communication of the first output advice to the decision maker.

14. The decision-assistance server of claim 13, comprising:
an account-processing module, the account-processing module arranged to service a plurality of registered user accounts, the account-processing module arranged to associate at least some of the plurality of registered user accounts with individuals, respectively, and others of the plurality of registered-user accounts with businesses, respectively.

15. The decision-assistance server of claim 14 wherein the account processing module is arranged to manage more than 100,000 registered-user accounts.

16. The decision-assistance server of claim 15 wherein the decision-processing module is arranged to manage decision-to-be-made information associated with more than 100,000 active decisions to be made.

17. The decision-assistance server of claim 16 wherein the at least one theme-operations module is arranged to automatically determine theme information associated with each managed decision to be made.

18. The decision-assistance server of claim 17 wherein the decision-processing module is arranged to:
manage a plurality of subscriptions, each of the plurality of subscriptions identifying at least one theme;
determine when a theme is identified in an active decision to be made; and
direct communication of at least some of the second input information and at least some of the first output information to an account of a business subscribed to at least one theme.

19. The decision-assistance server of claim 16, comprising:
Timing logic arranged monitor how long each active decision to be made has been active.

20. The decision-assistance server of claim 16, comprising:
a database arranged store decision-to-be-made information associated with the more than 100,000 active decisions to be made.
